(19) United States
(12) Patent Application Publication
(10) Pub. No.: US 2009/0129749 A1
(43) Pub. Date: May 21, 2009

(54) VIDEO RECORDER AND VIDEO REPRODUCTION METHOD

(76) Inventors: Masayuki OYAMATSU, Yokohama (JP); Maki Furui, Tokyo (JP); Kazushige Hiroi, Machida (JP); Yoshitaka Hiramatsu, Sagamihara (JP); Minako Toba, Mitaka (JP); Takehito Kishi, Yokohama (JP); Tomochika Yamashita, Yokohama (JP); Norikazu Sasaki, Ebina (JP)

Correspondence Address: MATTINGLY & MALUR, P.C., 1800 DIAGONAL ROAD, SUITE 370, ALEXANDRIA, VA, 22314, US

(21) Appl. No.: 12/266,050

(22) Filed: Nov. 6, 2008

(30) Foreign Application Priority Data
Nov. 6, 2007 (JP) 2007-288794
Nov. 7, 2007 (JP) 2007-289155

(51) Int. Cl. H04N 7/08

(52) U.S. Cl. 386/95; 386/E05.028

(57) ABSTRACT

In a video recorder, closed caption sentence data is outputted by analyzing digital broadcasting data including closed caption information. Index data is generated on the basis of a feature extraction rule and the effectiveness of an appearing keyword by analyzing closed caption sentence data. Closed caption feature data including a type of a closed caption sentence and a display time is generated by analyzing a closed caption ES (Elementary Stream). The broadcasting data is stored as record data, the closed caption feature data is analyzed, chapter data for reproducing a program is generated by a chapter designated by the user, and the chapter data is outputted to a storage. In the case of recording and reproducing the digital broadcasting program, it is possible to perform both the reproduction by the optimal index using the closed caption and the reproduction by the keyword voluntarily inputted by the user.

### CLAIMS OF PRIORITY

The present application claims priority from Japanese patent applications JP 2007-288794 filed on Nov. 6, 2007, and JP 2007-289155 filed on Nov. 7, 2007, the content of which is hereby incorporated by reference into this application.

### BACKGROUND OF THE INVENTION

The present invention relates to a video recorder and a video reproduction method. More particularly, the present invention relates to a video recorder and a video reproduction method that are easily used to play a user's desired scene by selecting an optimal keyword included in a closed caption in every program having an index of the closed caption or a keyword inputted for a user to voluntarily search the scene at the time of recoding and reproducing a digital broadcasting program by receiving the digital broadcasting program. Or, the present invention relates to a video recorder that records and reproduces program data with closed caption data.

Recently, digital broadcasting that broadcasts an image in the form of digital data has become the main stream. Due to such digitalization, new broadcasting services such as high-definition broadcasting (high-vision broadcasting), multi-channel broadcasting, data broadcasting, mobile receiving (cellular phone, etc.)-specification broadcasting, etc. have become available.

As digital television broadcasting storage media, digital storage media, for example, optical disks such as a DVD (Digital Versatile Disk), etc. or a hard disk drive (HDD) etc., which can reserve programs in large quantities and rapidly or easily perform an editing or erasing operation are used. First, after a user records an interested program and can easily read the program at a user's desired time regardless of a broadcasting time as long as the capacity of the storage medium is allowed. Under such a circumstance, since a watchable time is limitative, the user wants to watch a user's desired scene by heading a first part of the scene.

In JP-A-2005-115607, there is disclosed a member of extracting a requirement scene regarded to be suitable for a user's requirement by searching a character string taking out closed caption information multiplexed and stored with the image.

In JP-A-2006-157108, there is disclosed a video recording apparatus that stores a keyword and a appearance time as index information during recording and the keyword and the generation time in a recording medium with a video signal in the case where a level of a scene is equal to or more than a criterion value.

In JP-A-2006-157108, there is disclosed that a level is granted due to a generation frequency of the keyword and a keyword having a predetermined level or more is recorded in the recording medium as the index information.

In JP-A-2005-115607, there is disclosed an apparatus that stores the closed caption information and extract the requirement scene regarded to be suitable for the user's requirement as a candidate, perform image analysis or sound analysis for the requirement scene, and as a result, extract a scene judged to satisfy the user's requirement. As described above, by using a closed caption, it is possible to save a trouble of accepting and preparing information on contents in comparison with the related art.

However, in JP-A-2005-115607, it takes a long time to search a packet including the closed caption at the time of searching for the closed caption information by taking out the multiplexed and stored closed caption information. It takes a long time to search for a scene. Since storing the closed caption information in a decoding state may come under content duplication, a violation of a standard or a problem in copyright may occur in contents under copy limitation.

In JP-A-2006-157108, there is disclosed that the level is granted by the generation frequency of the keyword and the keyword having the predetermined level or more is recorded in the recording medium as the index information.

In JP-A-2006-157108, there is disclosed that it is not necessarily proper that the level granted by only the generation frequency of the keyword is used as an index in accordance with the content of the program.

However, since only an index for a keyword automatically judged to be optimal by a system exists, a member for allowing the user to voluntarily select and search the keyword is not provided. As a result, a freedom degree is low. Meanwhile, a member for accurately informing the user of generation of the index for the content does not exist and a member for informing the user of a position of a scene corresponding to the keyword on an entire program does not exist, such that it is convenient to the user.

In order to solve the above-described problem, an object of the present invention is to enable a digital broadcasting program to be reproduced by an optimal index using a closed caption and to be reproduced by referring to a keyword voluntarily inputted by a user at the time of recording and reproducing the digital broadcasting program.

Another object of the present invention is to provide a user interface that displays a scene including the index in the closed caption so as to allow the user to easily recognize the scene.

An additional object of the present invention is to allow the keyword to be rapidly searched for the keyword voluntarily inputted by the user.

An object of a first aspect of the present invention is to play the digital broadcasting program by referring to an optimal index using the closed caption at the time of recording and reproducing the program.

### SUMMARY OF THE INVENTION

In order to solve the above-described problem, in a program recording apparatus of an aspect of the present invention, broadcasting data receiving digital broadcasting is separated and a closed caption ES is taken out. Closed caption sentence data that is composed of a closed caption sentence, and a control code and an indication time is outputted by analyzing the closed caption ES.

Index data is generated on the basis of a feature extraction rule and the effectiveness of an appearing keyword by analyzing the closed caption sentence data.

At the time of reproducing a recorded program, a position of a program using a keyword from an index selected by a user is displayed on a program reproducing screen to be visually and easily understood on the basis of index data, and the recorded program is reproduced from the position of the program of the keyword.

Further, the position of the program using the keyword inputted by the user is displayed so as to be visually and easily understood on the basis of the index data by allowing the user to input the keyword through the program reproducing screen, and the recorded program is reproduced from the position of the program of the keyword.

In the case where plural categories corresponding to one program are installed, a keyword to be searched is changed.

It is preferable that other aspects of the present invention are configured as described in the appended claims, for example.

### BRIEF DESCRIPTION OF THE DRAWINGS

FIG. 1 is a block diagram illustrating the configuration of a video recorder according to a first embodiment of the present invention;

FIG. 2 is a diagram illustrating a data structure of a data stream in digital broadcasting;

FIG. 3 is a diagram illustrating the form of closed caption sentence data 120;

FIG. 4 is a diagram illustrating a data structure of index data 123;

FIG. 5 is a flowchart illustrating a process of generating index data in a video indexing unit 114;

FIG. 6 is a flowchart illustrating an output process of the index data in detail;

FIG. 7 is a flowchart illustrating a process at the time of recording a program;

FIG. 8 is a flowchart illustrating a process of informing a user of whether or not an index is generated by a keyword included in a closed caption;

FIG. 9 is a diagram illustrating a program list screen in the case where it is judged whether or not the index is generated by the closed caption is presented to the user;

FIG. 10 is a diagram illustrating an example of a user interface of a program reproduction screen that performs index reproduction using the closed caption;

FIG. 11 is a block diagram illustrating the configuration of a video recorder according to a second embodiment of the present invention;

FIG. 12 is a block diagram illustrating the configuration of a video recorder according to a third embodiment of the present invention;

FIG. 13 is a block diagram illustrating the configuration of a video recorder according to a fourth embodiment of the present invention;

FIG. 14 is a diagram illustrating a data structure of a data stream in digital broadcasting;

FIG. 15 is a diagram illustrating the form of closed caption feature data 1320;

FIG. 16 is a diagram illustrating a data structure of chapter data 1323;

FIG. 17 is a flowchart illustrating a process of generating chapter data in a chapter generation unit 1314;

FIG. 18 is a flowchart illustrating an output process of chapter data in detail;

FIG. 19 is a flowchart illustrating a process at the time of recording a program;

FIG. 20 is a flowchart illustrating a process at the time of recording a program; and

FIG. 21 is a diagram illustrating an example of a user interface of a program reproduction screen that performs chapter reproduction using a closed caption.

### DETAILED DESCRIPTION OF THE PREFERRED EMBODIMENTS

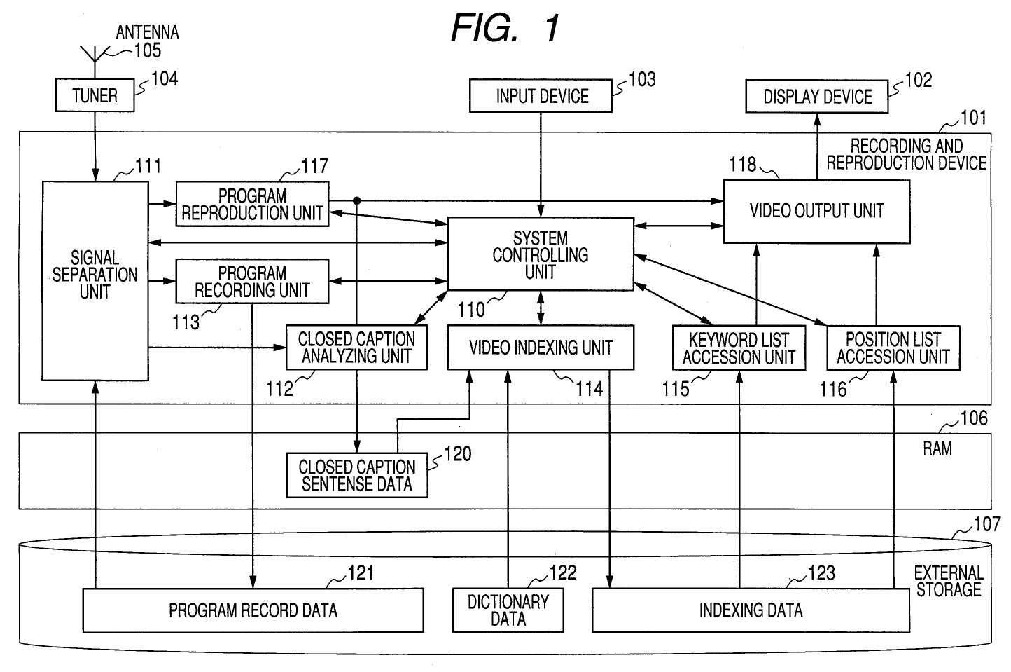

Hereinafter, embodiments of the present invention will be described with reference to FIGS. 1 to 21.

### First Embodiment

Hereinafter, a first embodiment of the present invention will be described with reference to FIGS. 1 to 10.

First, referring to FIG. 1, the configuration of a video recorder according to a first embodiment of the present invention will be described.

FIG. 1 is a block diagram illustrating the configuration of the video recorder according to the first embodiment of the present invention.

As shown in FIG. 1, the video recorder includes a program recording and reproduction device 101, a display device 102, an input device 103, a tuner 104, an antenna 105, a RAM 106, and an external storage 107.

The recording and reproduction device 101 is a part that records or reproduces a broadcasting program in the external storage 107. The recording and reproduction device 101 is divided into processing blocks for performing processes in recording and reproducing the program.

The display device 102 is a part that displays the video or the audio. The display device 102 displays a video and outputs audio in the case where recorded contents are reproduced. The display device 102 includes a display or a liquid crystal panel of a television or a PC, etc.

The input device 103 is a device that inputs control information or data on operations inputted by a user after the user operates the video recorder. The input device 103 is realized by a remote controller, a keyboard, a mouse, a pointing device such as a pen input device, a liquid crystal touch panel, or the like, for example.

The RAM 106 is a volatile memory and is a storage that stores temporary data or program processed by the recording and reproduction device 101.

The tuner 104 is a part that acquires broadcasting program data tuned by radio waves received from a broadcasting station.

The antenna 105 is a part that receives broadcasting waves for each digital broadcasting band. For example, an antenna for terrestrial digital broadcasting receives radio waves of a UHF band.

The external storage 107 is a device that has a large storage capacity and includes an optical disk such as a DVD, etc. or a HDD, for example.

Next, each processing block of the recording and reproduction device 101 will be described. Each processing block may be processed by software operating in a general-purpose processor such as a CPU, etc. or hardware for exclusive use for each block. Each block may be processed by a device including the software and the hardware.

As shown in FIG. 1, the recording and reproduction device 101 includes a system control unit 110, a signal separation unit 111, a closed caption analyzing unit 112, a program recording unit 113, a video indexing unit 114, a keyword list accession unit 115, a position list accession unit 116, a program reproduction unit 117, and a video output unit 118.

The system control unit 110 controls an operation of each block of the recording and reproduction device 101 by receiving a user's operation request through the input device 103. Further, the system control unit 110 controls the operation of each block of the recording and reproduction device 101 in recording and reproducing a program.

The signal separation unit 111 separates received broadcasting data, video data, audio data, a closed caption sentence data, program information data, etc. by each type to other processing blocks. In the case where the signal separation unit 111 receives a request for data transmission from other processing units, the signal separation unit 111 transmits designated data to a request source. Further, the broadcasting program data received from the tuner 104 or recording program data 121 stored in the external storage 107 may be inputted into the signal separation unit 111.

The keyword list accession unit 115 analyzes index data 123 (to be described below) stored in the external storage 107 and acquires a keyword list presented to the user at the time of reproducing the program to output the keyword list to the video output unit 118 by a direction of the system control unit 110.

The position list accessing unit 116 outputs a reproduction position list for the keyword indicated by the user to the video output unit 118 by the direction of the system control unit 110.

The program recording unit 113 acquires the recording program data 121 stored in the external storage 107, which is indicated by the user to input the recording program data 121 into the signal separation unit 111 by the direction of the system control unit 110. Thereafter, the program recording unit 113 acquires and decodes a video ES (to be described below) and an audio ES (to be described below) from the signal separation unit 111 to output the video data and the audio data to the video output unit 118.

The program recording unit 113 requests a data stream to the signal separation unit 111 and stores the recording program data 121 in the external storage 107 through the system control unit 110 in the case of receiving a request for recording the program. The program recording unit 113 may store all data streams as the recording program data 121 by user's designation or may store only the video ES or audio ES by selection due to a reduction in a storage area.

The video output unit 118 configures a screen by receiving an output of the keyword list accession unit 115, the position list accession unit 116, or the program reproduction unit 117 and outputs the video and the audio to the display device 102.

When the closed caption analyzing unit 112 receives a request for analyzing a closed caption from the system control unit 110, the signal separation unit 111 acquires a closed caption ES (to be described below) and a time stamp. The closed caption analyzing unit 112 analyzes the closed caption ES and stores closed caption sentence data 120 in the RAM 106.

The video indexing unit 114 outputs index data 123 to the external storage 107 by using the closed caption sentence data 120 and dictionary data 122.

The closed caption sentence data 120 is the data that the closed caption analyzing unit 112 stores in the RAM 106 after analyzing the closed caption ES. The closed caption sentence data 120 will be described in detail below.

The external storage 107 stores the recording program data 121, the dictionary data 122, and the index data 123.

The dictionary data 122 is the data in which keywords to be outputted as indexes are listed. The index is an entry word, that is, an index that the user can designate at the time of reproducing the program. However, in the case where a blank section of the closed caption sentence data 120 is detected, while contents of the closed caption are not analyzed, the dictionary data 122 may not be provided. The dictionary data 122 is not in only the external storage 107, but the dictionary data 122 may be accessed by Internet, broadcasting waves, a flash memory, etc. A dictionary may be updated from a user's operation history or EPG.

The recording program data 121 is the program data including information such as the video, the audio, the closed caption, etc.

The index data 123 is the data storing the information on the keywords contained in the closed caption. The index data 123 will be described in detail below.

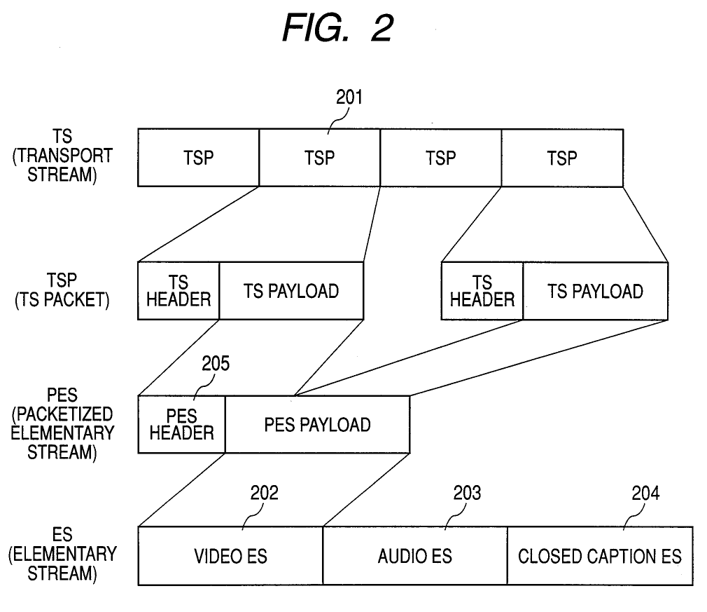

Next, referring to FIGS. 2 to 4, a data structure relating to a video reproduction method according to the embodiment of the present invention will be described.

FIG. 2 is a diagram illustrating a data structure of the data stream in digital broadcasting.

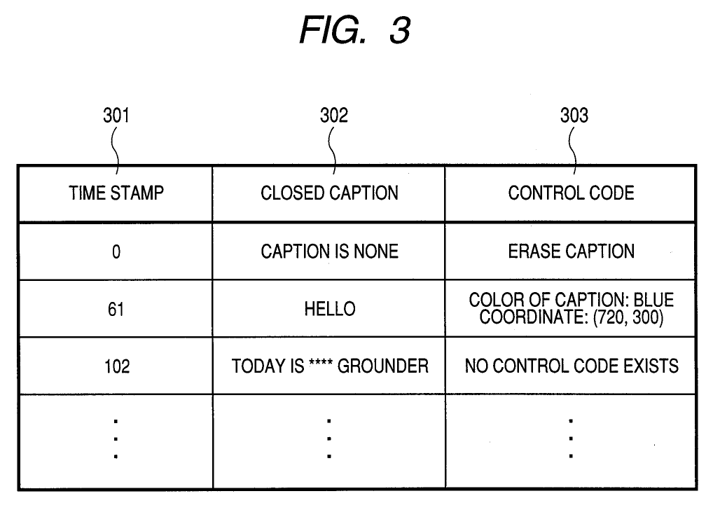

FIG. 3 is a diagram illustrating the form of the closed caption sentence data 120.

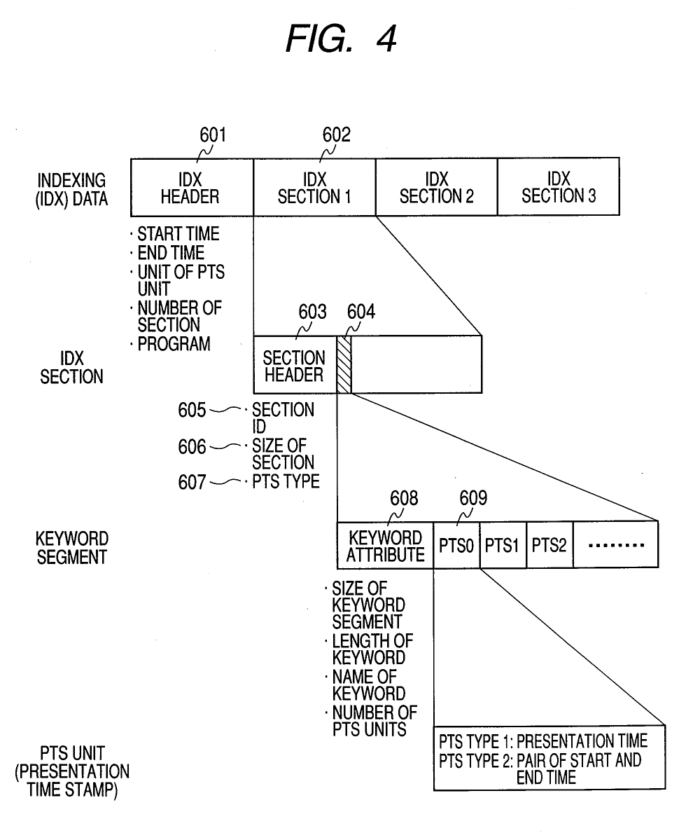

FIG. 4 is a diagram illustrating a data structure of the index data 123.

In the digital broadcasting, an MPEG-2 TS (Transport Stream) is used as a transmission scheme. The video data, the audio data, all the data that are used for data broadcasting are transmitted to a TS packet 201 shown in FIG. 2.

In particular, the video data, the audio data, and the closed caption sentence data are encoded and compressed in elementary streams to become a video ES 202, an audio ES 203, and a closed caption ES 204. The ESs are packetized in the form of a PES (Packetized Elementary Stream) to which a PES header 205 indicating display time information. The PES header 205 includes the time stamp. Reproduction synchronization of each packet may be maintained by the time stamp. As known from FIG. 2, one PES packet may be made by the payload of plural TS packets.

The signal separation unit 111 shown in FIG. 1 analyzes the data streams of FIG. 2 to separate the data stream by each packet type.

Next, referring to FIG. 3, the closed caption sentence data 120 will be described.

As shown in FIG. 3, the closed caption sentence data 120 is stored in a table format of a time stamp 301, a closed caption sentence 302, and a control code 303.

The time stamp 301 is a closed caption display time included in the PES header 205 and is displayed as a relative time from a recording start time.

The closed caption sentence 302 is text information included in the closed caption ES 204.

The control code 303 is the data for controlling, for example, a font color or an image position or closed caption display such as erasing included in the closed caption ES 204.

When the system control unit 110 requests the closed caption display, the time stamp 301 is monitored and when the display time is reached, the closed caption sentence 302 and the control code 303 are transmitted to the video output unit 118 and displayed as the closed caption.

The closed caption sentence data 120 is accumulated in a predetermined amount depending on the capacity of the RAM 106. The closed caption analyzing unit 112 monitors the accumulated data amount of the closed caption sentence data 120. In this case, in the case where the closed caption analyzing unit 112 determines that the data of a predetermined amount is accumulated in the RAM 106, the closed caption analyzing unit 112 notifies the system control unit 110.

Next, referring to FIG. 4, the index data 123 will be described.

The index data 123 is the data generated for each program and the information on the keyword included in the closed caption. The index data 123 may be used in generating the program using the index.

As shown in FIG. 4, the index data 123 has a hierarchical structure. The uppermost layer includes one index header (hereinafter, referred to as ‘IDX header’) 601 at the header of the layer and plural index sections (hereinafter, referred to as ‘IDS section’) 602 next to the index header.

The IDX header 601 includes data serving as an attribute of the index data and only one information piece such as the recording start time or a termination time and the unit of a PTS (Presentation Time Stamp) which is a time indicated by the index or the program information. In addition, the IDX header 601 includes the total number of the IDX sections 602. The program information is acquired from an EPG. Besides, additional information may be added to the program information while recording such as setting an image quality.

The IDX section 602 is prepared by being separated from other IDX sections in accordance with a difference in an attribute of the keyword or a keyword usability determination algorithm. For example, in the case where the IDX sections have different categories of the program, different attributes of the keyword or the keyword usability determination algorithm may be used. Therefore, the IDX sections are prepared in correspondence with the categories of the program. For example, since a category called a baseball program and a category called a news program are different in the attribute of the keyword and the keyword usability determination algorithm, an independent IDX section is prepared for each program.

As shown in FIG. 4, each IDX section is partitioned by plural segments having the hierarchical structure. One section header 603 is configured at the header of the IDX section and plural keyword segments 604 are configured at the next to the section header 603.

The section header 603 is the segment representing an attribute of the IDX section. The section header 603 may include a section ID 605, a section size 606, and a PTS type 607, for example.

The section ID 605 is the ID number representing an attribute of the section aid is unique for each IDX section included in the same index data. It is preferable that the program reproduction device treating the index data uses the same section ID in the case where index data of each of plural programs uses the same keyword usability determination algorithm in order to determine a using method of the corresponding IDX section by examining the section ID.

The section size 606 represents an entire size of the corresponding segment. The PTS type 607 is the code for discriminating an expression method of the PTS included in the keyword segment 604. An example of the expression method of the PTS will be described below.

The keyword segment 604 is the segment for storing the keyword and an appearance position thereof. The keyword segment 604 has a hierarchical structure in which the keyword segment 604 is divided into plural units. The keyword segment 604 includes one keyword attribute 608 formed at the head of the keyword segment 604 and plural PTS units 609 formed at the next of the keyword attribute 608.

The keyword attribute 608 includes a keyword segment size 610 which is a size of the keyword segment, a keyword length 611, a keyword name 612, and a PTS unit number 613 representing the number of PTS units included in the keyword segment, for example.

The PTS unit 609 represents the appearance position of the keyword or a position of a scene where the keyword appears. In the PTS unit 609, a method of storing the appearance position of the keyword or the position of the scene where the keyword appears is different depending on the PTS type 607 included in the section header 603. For example, in the PTS type 607, if Type 1 is indicated, only an appearance time for the keyword is stored, while if Type 2 is indicated, the appearance position of the keyword or the position of the scene where the keyword appears is stored depending on a start time and a termination time of the scene where the keyword appears.

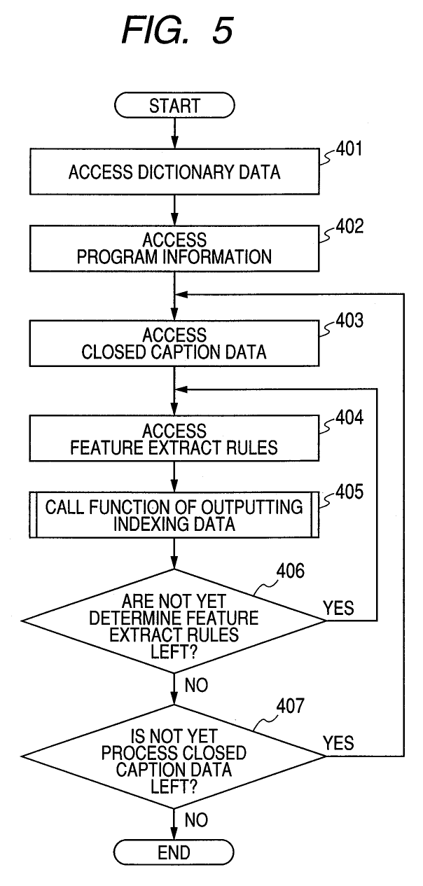

Next, referring to FIGS. 5 to 10, processing each unit of a video reproduction method according to a first embodiment of the present invention will be described.

FIG. 5 is a flowchart illustrating a process of generating index data in a video indexing unit 114.

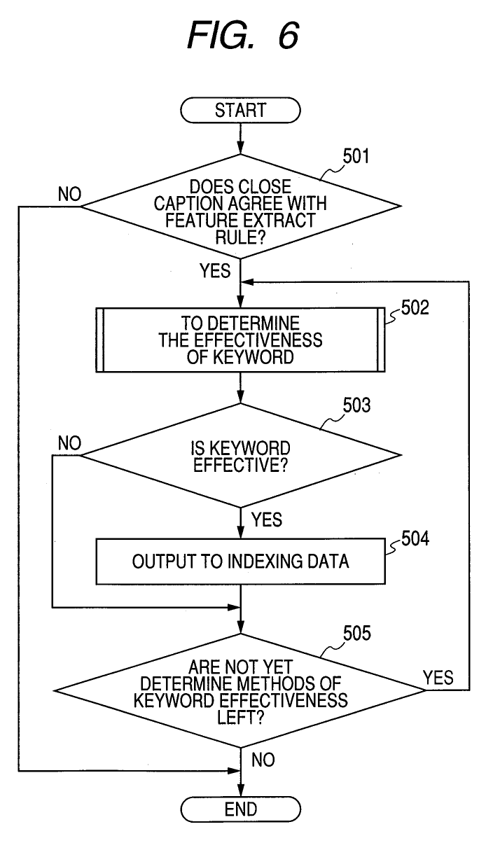

FIG. 6 is a flowchart illustrating an output process of the index data in detail.

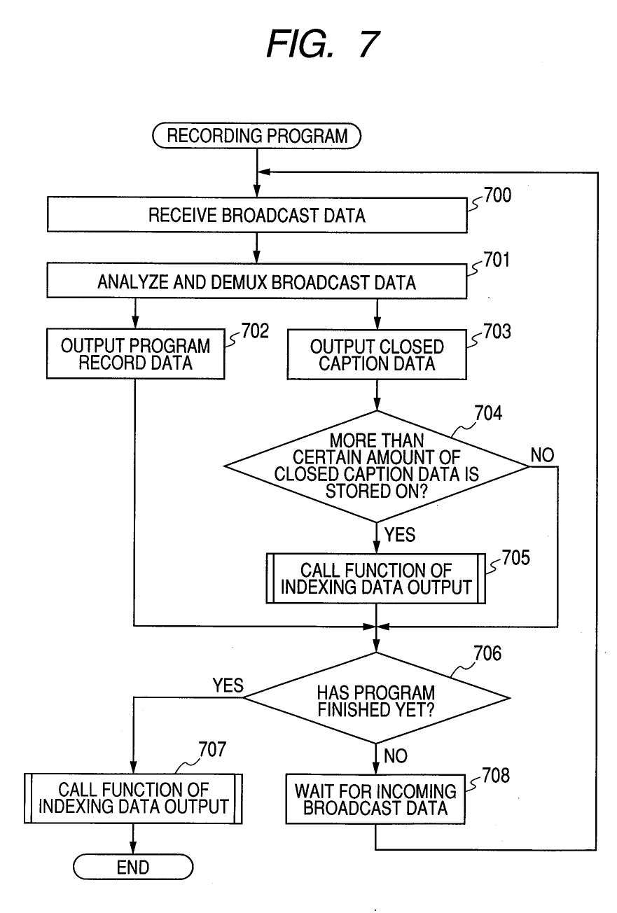

FIG. 7 is a flowchart illustrating a process at the time of recording a program.

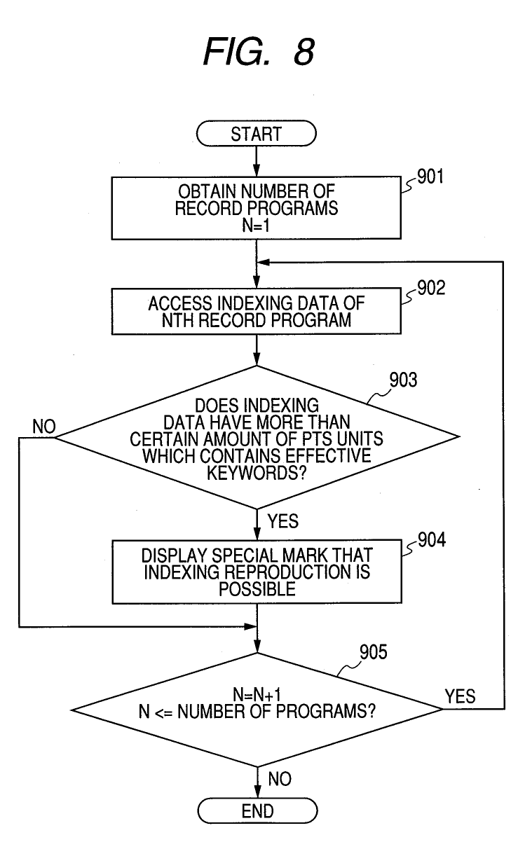

FIG. 8 is a flowchart illustrating a process of informing a user of whether or not an index is generated by a keyword included in a closed caption.

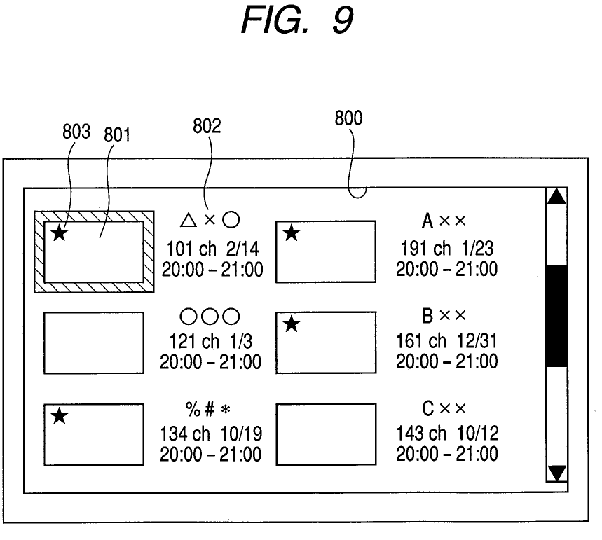

FIG. 9 is a diagram illustrating a program list screen in the case where whether or not the index is generated by the closed caption is presented to the user.

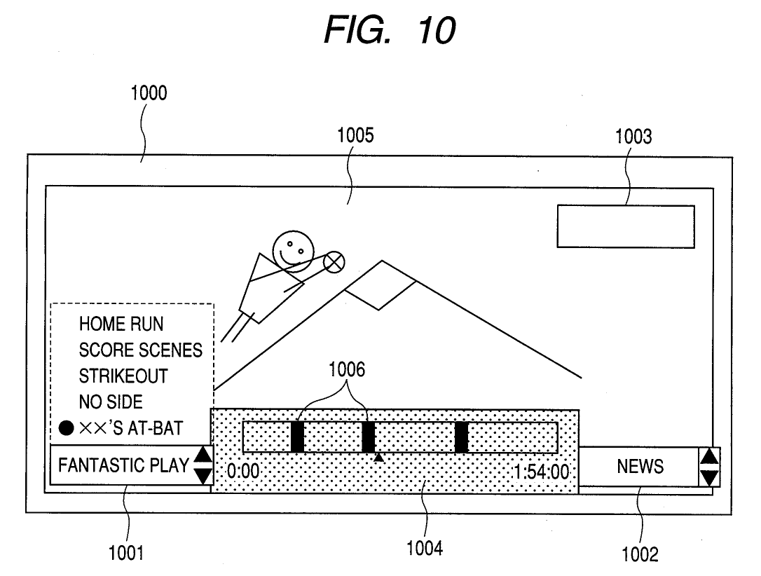

FIG. 10 is a diagram illustrating an example of a user interface of a program reproduction screen that performs index reproduction using the closed caption.

First, referring to FIG. 5, the process of generating the index data in the video indexing unit 114 will be described.

The video indexing unit 114 directs a start of the process of generating the index data in the system control unit 110.

The video indexing unit 114 firstly acquires dictionary data 122 in an external storage 107 (S401).

Next, the video indexing unit 114 acquires program information (S402). The program information is an electronic program guide (EPG) of digital broadcasting. The program information is acquired from a signal separation unit 111 by analyzing the broadcasting data or the recording program data 121 shown in FIG. 2.

In the closed caption sentence data 120 shown in FIG. 3, the time stamp 301, the closed caption sentence 302, and the control code 303 are acquired as one record (S403).

One feature detection rule is acquired (S404). The feature detection rule is the rule that may be used for determining whether or not the inputted closed caption sentence data 120 has a specific pattern, for example, determining whether or not the closed caption sentence data 120 includes the dictionary keyword acquired in S401 of FIG. 4 or finding a predetermined control code for emphasizing the closed caption. Since the keywords of the closed caption sentence data 120 are often contextually repeated, second or later repeated keywords do not have a feature, a specific keyword of the closed caption sentence data 120 does not appear in a predetermined section or more, and when the specific keyword of the closed caption sentence data 120 exists thereafter, the closed caption sentence data 120 conforms to the feature detection rule.

Although not shown in FIG. 1, the feature detection rule may be stored in a recording and reproduction device as control data of the video indexing unit 114 or may be taken out as necessary after being stored in the external storage 107.

Next, the index data is outputted on the basis of the closed caption sentence data and the feature detection rule acquired in S403 and S404, respectively (S405).

The output of the index data will be described below in detail with reference to FIG. 6.

After the output of the index data in S405 is terminated, whether or not there is an undetermined feature extraction rule is determined (S406).

In the case where there is an additional feature extraction rule, the process returns to S404 and the index data is outputted by acquiring another feature extraction rule.

In the case where all feature extraction rules are applied, whether or not the closed caption sentence data 121 remains is determined (S407).

In the case where another closed caption sentence data 121 remains, the process returns to S403 and the following caption sentence data is acquired.

After the processes of S403 to S406 are applied to all caption sentence data 121, the video indexing unit 114 terminates the process of generating the index data.

Next, referring to FIG. 6, the output of the index data will be described in detail.

First, it is determined whether or not the closed caption sentence data 121 acquired in S403 of FIG. 4 conforms to the feature detection rule (S501).

In the case where it is determined that the closed caption sentence data 120 conforms to the feature detection rule, the process is terminated.

In the case where it is determined that the closed caption sentence data 120 conforms to the feature detection rule, the usability of the keyword is determined on the basis of a determination method of the usability of any keyword (S502). In S403, words relating to the dictionary keyword or words similar to the dictionary keyword may be also searched at the same time. For example, in the baseball program, in case of a dictionary keyword called ‘score scene’, it is determined whether or not the dictionary keyword called ‘score scene’ is a keyword representing ‘timely hit’ or ‘home run’, which contains a score, at the same time.

In determination of the usability of the keyword, it is determined whether or not the keyword acquired in the process of S403 is outputted as the index data in accordance with the kind of the recording program. The usability of the keyword is determined by an appearance frequency or gap of a context or a keyword of surrounding closed caption sentence, or a rule of a control code.

For example, the score scene or fine play may be used as a scene which the user generally selects and reproduces in the baseball program. Herein, even though a keyword related to the score scene is included in the closed caption sentence 301, a sentence “A batter hits a home run on his second at bat today.” Just describes a batter's past play, thus, the scene is not associated with a user's desired scene. As a result, even though the keyword is included in the closed caption, it is judged that the keyword is not included in the score scene. In the case where a word “home run” is detected, there is the same word as the “home run” in a predetermined section before and after appearing, the usability is determined. This is because a scene after a second round is just repeated description after the second time, thus, it is regarded that the scene is not effective as the information and it is guessed that a lot of score scenes including the “home run” appear.

The method of determining the usability of the keyword may be different for each category of the program. Even in one program, when it is grasped that a music program and a variety program belong to different categories, the effectiveness of the keyword is changed. The effectiveness of the keyword may be determined by classifying categories into a higher concept and a lower concept, for example, a category called ‘sport’ and a category called ‘baseball’ with respect to an on-the-spot program of the baseball.

In the case where the determined keyword is an effective keyword, (S503), the index data 123 is outputted in accordance with the form shown in FIG. 4 (S504).

At this time, the index data 123 is outputted so that one IDX section 602 is configured for one category. Therefore, in one program, in the case where the category is classified into plural categories, plural IDX sections 602 are created.

If the program has many categories, and a calculation amount or the index data 123 for determining the effective keyword is increased, output categories may be reduced by adopting a member for restricting the category. For example, in the program information included in the EPG of the digital broadcasting, plural genre codes may be granted to one program. Accordingly, the index data 123 is outputted so that a separate IDX section 602 is configured for each genre code by judging the effective keyword by an algorithm suitable for a genre which can be acquired by the genre code.

A detailed sequence for outputting the index data will be described below.

First, in accordance with the determination method used for the method of determining the effective keyword, it is determined to which IDX section 602 the index data is outputted from the IDX section 602 included in the index data shown in FIG. 4. If there is no proper IDX section 602, a new IDX section 602 is created.

Next, it is determined whether or not the output keyword is included in each keyword segment 604. If there is a keyword segment 604 having the same keyword name 612 as the output keyword, a reproduction position of the keyword is outputted to the PTS unit 609 of the corresponding keyword segment depending on the PTS type thereof. If there is no keyword segment 604 having the keyword name 612 as the output keyword, a new keyword segment 604 is added. After the reproduction position of the output keyword is added to the keyword segment 604, the keyword segment size 610 and the section size 606 are updated.

Herein, a method of outputting the added reproduction position is changed depending on the IDX section. For example, the reproduction position may be outputted in accordance with the time stamp of the closed caption sentence data. In a live program such as a news program, etc, an appearance time of the keyword and an appearance time of a broadcasting closed caption may be shifted. Therefore, the reproduction time corresponding to the output keyword may be set to a predetermined time before the time stamp of the closed caption sentence data in the case where whether or not a recording program is live is detected from the program information. In the case where a section where the closed caption sentence is consecutive is detected as the scene, the section is stored in the PTS unit in the form of a PTS type 2 shown in FIG. 2.

After the index data 123 is outputted, it is determined whether or not a method of determining all the effective keywords supported by the recording and reproduction device is used with respect to the closed caption sentence data (S505). Moreover, in the case where there is another effective keyword determination method to be applied, the process returns to S502 and another effective keyword determination method is applied. Meanwhile, in the case where all effective keyword determination methods are applied, the process is terminated.

Next, referring to FIG. 7, processing the program recording and reproduction device in recording the program will be described.

When the user directs recording the program, the recording program data 121 is outputted and the index data 123 is created in accordance with the processing shown in FIG. 7.

First, the system control unit 110 directs a change of a program recording state by reservation recording of the program or a user's recording direction. The signal separation unit 111 separates the broadcasting data having the format shown in FIG. 2 on the basis of a transmission request registered before analysis and recording at the time of receiving the broadcasting data (S701). Thereafter, the signal separation unit 111 transmits desired data to the program recording unit 113 and the closed caption analyzing unit 114. The program recording unit 113 records the recording program data 121 in the external storage 107 (S702).

Meanwhile, at the same time, the closed caption ES 204 is inputted into the closed caption analyzing unit 112 and the closed caption analyzing unit 112 outputs the closed caption sentence data 122 (S703). Herein, the video indexing unit 114 is used to evaluate the closed caption sentence data included in a predetermined section at the time of judging the effectiveness of the keyword which may be used in S502 which is shown in FIG. 6. At this time, the closed caption sentence data 120 of a predetermined amount is accumulated in the RAM 106. In the case where the closed caption sentence data 120 of the predetermined amount or more is accumulated in the RAM 106 (S702), the closed caption analyzing unit 112 notifies the system control unit 110. When the system control unit 110 is notified from the closed caption analyzing unit 112, the system control unit 110 directs the video indexing unit 114 of the generation process of the index data, which is described in FIG. 5.

In the case where it is judged that the closed caption sentence data 120 of the predetermined amount or more is not accumulated in the RAM 106, it is judged whether or not the program is terminated (S706). In this case, when the program is terminated, the index data is generated by using the closed caption sentence data 120 on the RAM 106 (S707), thus, the process is terminated. When the program is not terminated, a broadcasting data receiving stand-by state is again maintained thereafter (S708).

Next, referring to FIGS. 8 and 9, a process of showing the user whether the index can be reproduced by using the closed caption will be described.

As shown in FIG. 9, when the index can be reproduced by using the closed caption, a gist thereof is displayed on a program list screen 800 displayed on the display device 102.

Herein, the index generation means the reproduction using the index data 123 prepared by the closed caption.

The program list screen 800 displays plural program thumbnails 801 and program information 802 of the recorded program. Herein, a recording program device generates the index data 123. An index reproducible mark 803, for example, an asterisk is attached to an index reproducible program by the keyword included in the closed caption. This may be expressed by a message “index reproduction” or by changing a color of the program thumbnail 801.

In the process of showing the user whether or not the index can be reproduced by using the closed caption, the number N of recording programs which is stored in the external storage 107 is firstly acquired (S901).

Next, the index data 123 of an N-th program is acquired (S902).

The keyword list accession unit 115 analyzes the index data 123 and judges the effectiveness of the index data 123 in accordance with a category of a target program.

Hereinafter, the process of judging the effectiveness of the index data 123 will be described in detail. Herein, the category of the program is classified by information such as the genre of the program or a program title, a broadcasting time zone, and a broadcasting station, etc., for example. For example, in case of the baseball program, the index can be reproduced by designating a chapter including an appearing position of a keyword relating to the score scene and a strikeout scene.

First, it is judged whether or not an IDX section 602 corresponding to the category of the baseball program is included in the index data shown in FIG. 4. When the IDX section 602 corresponding to the category of the baseball program is not included in the index data shown in FIG. 4, the index data 123 becomes ineffective. When the IDX section 602 corresponding to the category of the baseball program is included in the index data shown in FIG. 4, it is judged whether or not there is the keyword segment 604 including a keyword name representing the score scene. When there is the keyword segment 604 including a keyword name representing the score scene, the number of PTS units 609 included in the keyword segment 604 is required. When there is no keyword segment 604 including the keyword name representing the score scene, the number of PTS units 609 is set to 0. Likewise, the number of PTS units 609 for a keyword name representing the strikeout scene is required.

In case of the effectiveness of the index data 123, in the case where the number of PTS units of at least any one of the score scene and the strikeout scene is equal to or more than a predetermined number, it is judged that the index data 123 of the corresponding program is effective (S903).

As described above, in the case where it is judged that since the index data 123 is effective, the index can be reproduced by using the closed caption, a mark indicating that the index can be reproduced is displayed by using the closed caption for the N-th program (S904).

Thereafter, the processes of S902 to S904 are applied to all programs. When processing all the programs is terminated (S905), the process is terminated.

By the above steps, the user can find out that the index can be reproduced by using the closed caption by the mark attached to the program, which corresponds to the program list screen 800.

In the process of showing the user whether or not the index can be reproduced by using the closed caption, the effectiveness of the index data 123 is judged for all the programs whenever the program list screen 800 is displayed in the above-described example. Herein, in order to reduce a load at the time of displaying the program list screen 800, a result of judging the effectiveness of the index data 123 is stored in, for example, the recording program data 121 and the index reproducible mark 803 is attached to the index reproducible program by referring to the judgment result. By this method, the effectiveness of the index data 123 may be judged only once, thus, it is possible to reduce the load at the time of displaying the program list screen 800.

In addition to the above-described method, the index data 123 may be deleted from a program judged that the index cannot be reproduced by the judgment result of the effectiveness of the index data 123. At the time of displaying the program list screen 800 by executing the method, in the case where there is the index data 123, the index reproducible mark 803 is attached. By this method, it is likewise possible to reduce the load at the time of displaying the program list screen 800 and in addition, to increase an empty capacity of the external storage 107.

Next, referring to FIG. 10, a user interface at the time when the user reproduces the index by using the closed caption will be described.

A program reproduction screen 1000 that is capable of reproducing an index according to the embodiment of the present invention includes an index selection menu 1001, a category selection menu 1002, a keyword input column 1003, a progress bar display unit 104, and a program video display unit 105.

The program reproduction screen 1000 capable of reproducing the index according to the embodiment of the present invention is actuated when a program marked with the asterisk 803 of FIG. 9 is selected and the user directs the index reproduction using the closed caption through the input device 103.

As shown in FIG. 10, the index selection menu 1001 is the menu that allows the user to select an index used for generation by presenting the home run or the score scene to the user. The index is shown to the user for reproducing the program. In the embodiment, although the index agrees with the keyword of the closed caption is described, another display word related to the keyword, a word associated from the keyword, or a higher concept of the keyword may be used as the index. A keyword of the index displayed in the index selection menu 1001 is acquired by allowing the system control unit 110 to request the keyword list accession unit 115 to acquire a keyword list in displaying the program reproduction screen 1000. An IDX section 602 suitable for the category of the program is automatically selected from the index data 123 of the corresponding program and all keyword lists or some keyword lists are acquired from the keyword segment included in the IDX section 602 and are transferred to the video output unit 118.

As described later, the category of the program may be selected by the user through the category selection menu 1002.

The keyword list accession unit 115 outputs only a keyword having one or more PTS unit. The video output unit 118 displays the acquired keyword list in the index selection menu 1001.

When the user selects the index through the index selection menu 1001, display contents of a progress bar display unit 1004 also change. In the progress bar display unit 1004, a progress bar indicating an entire length of the program is displayed and a reproduction position of a chapter in accordance with a selection content of the index selection menu 1001 is displayed as an index position 1006.

In the index selection menu 1001, the index is selected, the position list reproduction unit 116 into which a keyword corresponding to a corresponding index selects an IDX section 602 corresponding to the category of the program from the index data 123 of the corresponding program and acquires all PTS units from the keyword segment 604 corresponding to the input keyword included in the IDX section 602. Subsequently, the acquired PTS unit 609 is transferred to the video output unit 118. The video output unit 118 displays a reproduction position of a chapter corresponding to the acquired PTS unit 609 on the progress bar. Herein, the video output unit 118 displays only an appearing position other than a standard color of the progress bar in the case where the PTS unit is the type 1 (appearing time type) shown in FIG. 4.

Meanwhile, in the case where the PTS unit is the type 2 shown in FIG. 6, an interval enclosed by start and termination times is displayed in a color other than the standard color of the progress bar. The progress bar display unit 1004 receives a user's keyword reproduction request through the input device 103, the progress bar display unit 1004 can reproduce the keyword by jumping to a chapter corresponding to the keyword.

As shown in FIG. 10, the category selection menu 1002 displays a category name such as baseball or news. When the category is changed, a keyword name of an index displayed on the index selection menu 1001 is also changed. All section IDs including effective keywords among the IDX sections 602 included in the index data 123 of the corresponding program by requesting the keyword list accession unit 115 to acquire the category list at the time of displaying the program reproduction screen 1000. The acquired section ID is converted into the category name and is out putted to the video output unit 118. The video output unit 118 displays the category name in the category selection menu 1002.

In the category selection menu 1002, when each category is selected, the IDX section 602 among the index data 123 is specified from the section ID corresponding to the corresponding category, and all or some keyword lists are acquired and transferred to the video output unit 118. The keyword list accession unit 115 outputs only a keyword having one or more PTS units. The video output unit 118 redisplays the acquired keyword list in the index selection menu 1001.

The user inputs a keyword which the user desired to search into the keyword input column 1003 through the input device 103. This search is called “free keyword search”. The keyword which the user inputs is called “free keyword”. When the beginning of the search is directed by inputting the keyword, acquisition of a reproduction position list for the keyword is requested to the keyword list accession unit 115. The keyword list accession unit 115 matches the keyword segments in all IDX sections 692 included in the index data 123 with the keyword names. As a result of matching the keyword segments with the keyword names, when the keyword segment that agrees with the keyword name is detected, the PTS unit 609 of the corresponding keyword is outputted to the video output unit 118. The video output unit 118 can reproduce a chapter corresponding to a position corresponding to the position of the PTS unit 609 or display the position of a video corresponding to the PTS unit 609 on the progress bar display unit 1004 by using the position indicated by the PTS unit 609. Meanwhile, when the keyword segment that agrees with the keyword name is not detected, a direction for displaying a message including a gist that nothing is detected is transferred to the video output unit 118.

As described above, the user can manually search a user's desired scene by allowing the user to automatically input the keyword. Further, it is possible to increase the hit ratio of the keyword searched by the user by outputting as many IDX sections 602 as possible to the index data 123.

In the program recording and reproduction device according to the embodiment of the present invention, the index data 123 is created as the closed caption data of the digital broadcasting, but a scene detection result in other than the closed caption may be reflected to the index data 123 by analyzing the video and the sound. For example, a separate IDX section may be outputted by using a telop recognition result or a CM detection result in the video.

In the program recording and reproduction device according to the embodiment of the present invention, in the case where the recording program data 121 is copied or transferred to a separate recording medium from the external storage 107, the recording program data 121 may be transferred with the index data 123. For example, even in a reproduction-only player, the reproduction using the closed caption can be performed by installing the keyword list accession unit 115 and the position list accession unit 116.

### Second Embodiment

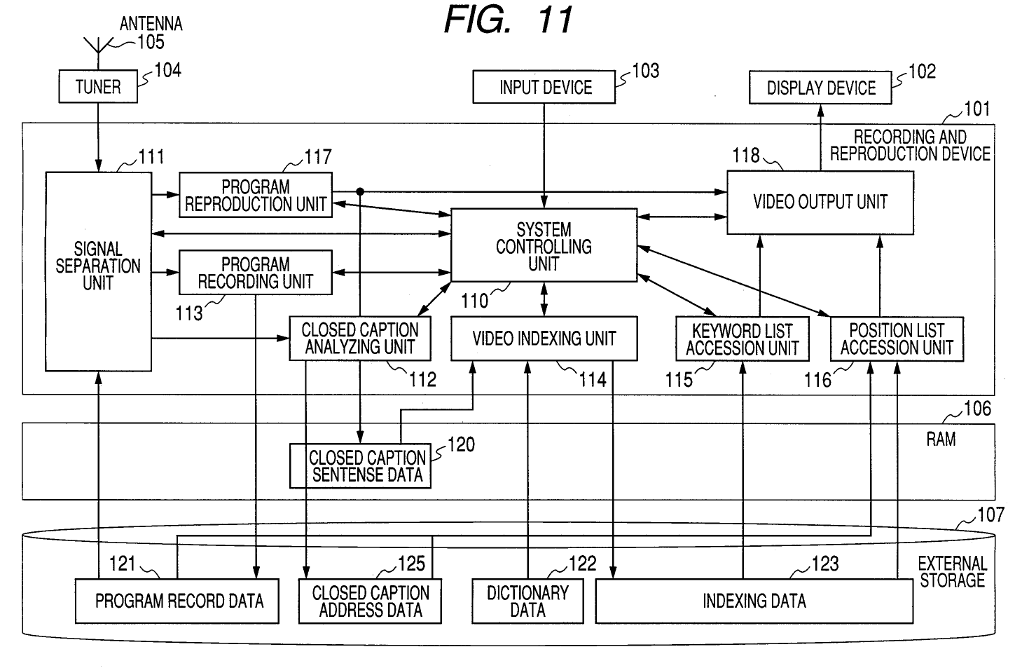

Hereinafter, a second embodiment according to the present invention will be described with reference to FIG. 11.

In the first embodiment according to the present invention, when a free keyword is searched, a search range is limited to the index data 123. In the present embodiment, in case of the search range, there is provided a member that can perform a high-speed searching operation from an entire closed caption ES included in contents.

Further, in the present embodiment, parts different from those of the first embodiment will be emphasized and described.

FIG. 11 is a block diagram illustrating the configuration of a program recording and reproduction device according to a second embodiment of the present invention.

As shown in FIG. 11, the configuration of the program recording and reproduction device according to the present embodiment of the present invention is different from that shown in FIG. 1 of the first embodiment. In the configuration of the program recording and reproduction device according to the present embodiment, the closed caption analyzing unit 112 outputs the closed caption address data 125. Closed caption address data 125 is an address list of a TS packet including a closed caption ES among TS packets included in the recording program data 121.

In the related art, when a search using the free keyword is performed from the recording program data 121, a position of the closed caption ES included in the recording program data 121 cannot be specified, thus, it takes a long time to analyze all packets at the time of searching the closed caption ES.

In the present embodiment, at the time of performing the free keyword search from the recording program data 121, only a packet of an address presented in the closed caption address data 125 is analyzed, it is possible to remarkably improve a search time.

The closed caption address data 125 is created while recording a program. In the program recording and reproduction device according to the present embodiment of the present invention, a process in recording the program is achieved by adding a process of creating the closed caption address data 125 to the flowchart of FIG. 7. In the present embodiment, in S701, the closed caption ES is transferred to the closed caption analyzing unit 112 and an address of the recording program data 121 of the TS packet including the closed caption ES is received. Since the TS packet in the digital broadcasting has a fixed length of 188 byte, a packet number is also acceptable and an actual address recorded in the actual external storage 107 is also acceptable.

The closed caption analyzing unit 112 outputs the index data to the closed caption ES in S705 and outputs the received address of the TS packet to the closed caption address data 125.

Next, a method of executing the free keyword search by using the closed caption address data 125 will be described.

The process of the present embodiment is different from the process of the first embodiment only in that the recording program data 121 and the closed caption address data 125 are added to the index data which is a target of the free keyword search.

First of all, similarly to the first embodiment, when the search is begun by inputting the keyword into the keyword input column 1003, acquisition of a reproduction position list for the corresponding keyword is requested to the keyword list accession unit 115 and the free keyword search is performed by using the index data 123 as the target. The PTS unit 609 of the corresponding keyword, which was searched by using the free keyword is outputted to the video output unit 118.

Meanwhile, in the case where the PTS unit 609 is not detected, address lists of the TS packets included in the closed caption address data 125 are sequentially acquired.

Next, the closed caption ES is inputted into the closed caption analyzing unit by analyzing the TS packet included in the recording program data 121 of the corresponding address in the signal separation unit 111. The closed caption analyzing unit 112 acquires a closed caption sentence by decoding the closed caption ES and matches the closed caption sentence with the free keyword of the searching target. If the free keyword of the searching target is included in the closed caption sentence, a time stamp of the closed caption sentence is outputted to the RAM 106.

Thereafter, processing all address lists of the TS packet included in the closed caption address data 125 is performed.

As the above-described processing result, when the free keyword is detected in the closed caption sentence, a time stamp list is outputted to the video output unit 118. Meanwhile, when the free keyword is not detected in the closed caption sentence, a direction for displaying a message including a gist that nothing is detected is transferred to the video output unit 118.

In the present embodiment, since the index data 123 is searched at first, the high-speed search is performed similarly to the first embodiment. Further, in the present embodiment, even though the free keyword is not detected in the closed caption sentence by the free keyword search using the index data as the target, the closed caption sentence itself can be searched at high speed, thereby improving the hit ratio of the keyword. Since data stored in the external storage 107 is just a packet address of the TS packet including the closed caption ES, the data does not matter in the copyright.

### Third Embodiment

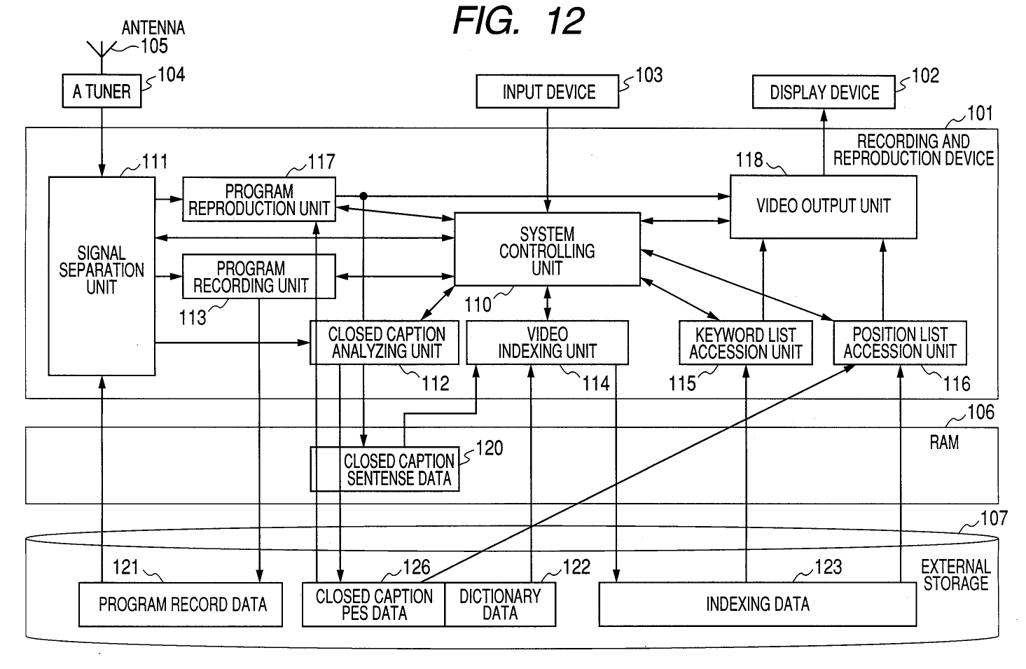

Hereinafter, a third embodiment of the present invention will be described with reference to FIG. 12.

In the second embodiment, the search is performed from the recording program data 121 with reference to the closed caption address data 125 in addition to the index data 123 at the time when the user performs the search using the free keyword. In the present embodiment, the closed caption ES is stored as data other than the recording program data. Since the closed caption sentence itself is not copied to an external medium, this does not matter in the copyright.

Further, in the present embodiment, parts different from those of the first embodiment will be emphasized and described.

FIG. 12 is a block diagram illustrating the configuration of a program recording and reproduction device according to a third embodiment of the present invention.

As shown in FIG. 12, the configuration of the program recording and reproduction device according to the present embodiment of the present invention is different from that shown in FIG. 1 of the first embodiment. In the configuration of the program recording and reproduction device according to the present embodiment, the closed caption analyzing unit 112 outputs closed caption PES data 126. The closed caption PES data 126 is acquired by sequentially outputting PES packets including the closed caption ES.

The closed caption PES data 126 is created while recording the program. In the program recording and reproduction device according to the present embodiment of the present invention, the process in recording the program is achieved by modifying a process relating to the closed caption PES data 126 from the flowchart of FIG. 7. In the present embodiment, in S701 of FIG. 7, the TS packet including the closed caption ES is prevented from being transmitted through filtering at the time of outputting the recording program data to the program recording unit 113. Further, the closed caption analyzing unit 121 acquires the PES packet from the TS packet including the received closed caption ES and outputs the PES packet as the closed caption PES data 126.

In the present embodiment, it is necessary that an ES relating to the closed caption is separated in broadcasting and the closed caption PES data 126 for displaying the closed caption is inputted directly into the program reproduction unit 117 as the PES packet at the time of reproducing the record data in order to store the data in the external storage 107.

Next, a method of performing the free keyword searching operation by using the closed caption PES data 126 will be described.

In the process of the second embodiment, the recording program data 121 and the closed caption address data 125 are added to the index data which is the target of the free keyword search.

In the process of the present embodiment, the closed caption PES data 126 is added to the index data 123 which is the target of the free keyword search.

First of all, similarly as the first and second embodiments, when the search is begun by inputting the keyword into the keyword input column 1003, acquisition of a reproduction position list for the corresponding keyword is requested to the keyword list accession unit 115 and the free keyword search is performed by using the index data 123 as the target. The PTS unit 609 of the corresponding keyword, which was searched by using the free keyword is outputted to the video output unit 118.

Meanwhile, in the case where the PTS unit 609 is not detected, the PES packets included in the closed caption PES data 125 are sequentially acquired. Subsequently, the corresponding PES packet is inputted into the closed caption analyzing unit 112. The closed caption analyzing unit 112 acquires the closed caption sentence by decoding the closed caption ES and matches the closed caption sentence with the free keyword of the searching target. If the free keyword of the searching target is included in the closed caption sentence, the time stamp of the closed caption sentence is outputted to the RAM 106. Thereafter, processing all packets included in the closed caption PES data 126 is performed.

As the above-described processing result, when the free keyword is detected in the closed caption sentence acquired from the closed caption PES data 126, the time stamp list is outputted to the video output unit 118. Meanwhile, when the free keyword is not detected in the closed caption sentence, a direction for displaying a message including a gist that nothing is detected is transferred to the video output unit 118.

In the free keyword search according to the present embodiment, since the PES packet relating to the closed caption is stored in the external storage 107 as a series of data, the frequency of data seeks in the search is low, thereby maintaining high speed.

### Fourth Embodiment

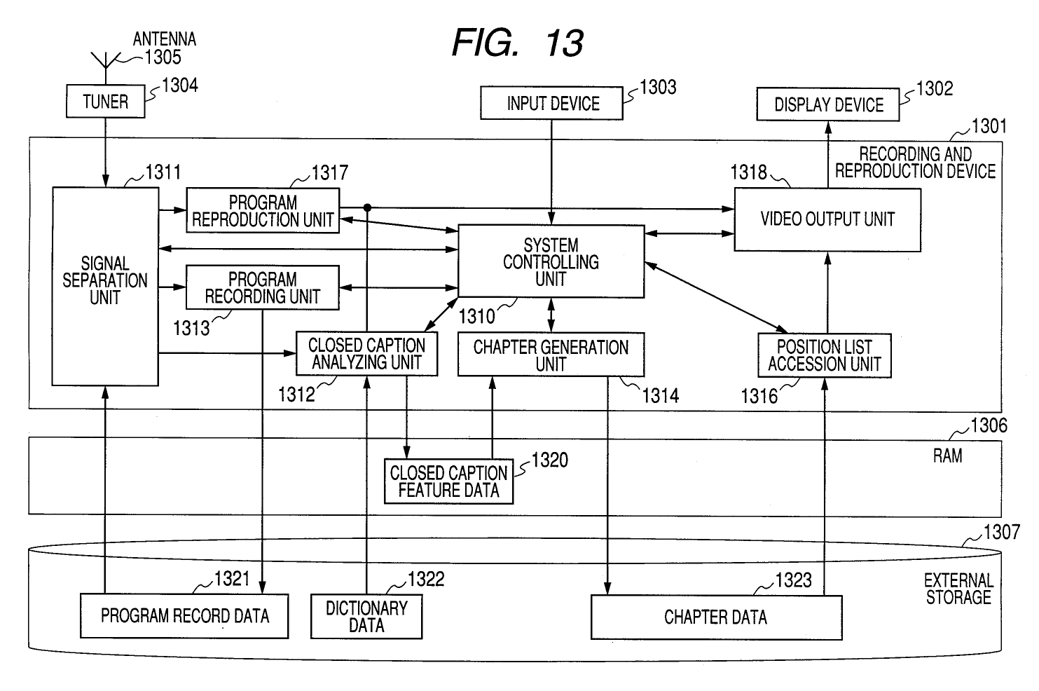

Hereinafter, a fourth embodiment will be described with reference to FIGS. 13 to 21.

First of all, the configuration of a recording and reproduction device according to a fourth embodiment of the present invention will be described with reference to FIG. 13.

FIG. 13 is a block diagram illustrating the configuration of the recording and reproduction device according to the fourth embodiment of the present invention.

As shown in FIG. 13, the recording and reproduction device according to the fourth embodiment of the present invention includes a recording and reproduction unit 1301, a display device 1302, an input device 1303, a tuner 1304, an antenna 1305, a RAM 1306, and an external storage 1307.

The recording and reproduction unit 1301 is a part that records and reproduces a broadcasting program in the external storage 1307. The recording and reproduction unit 1301 is divided into processing blocks for performing processes in recording or reproducing the program.

The display device 1302 is a part that displays a video or a sound. The display device 1302 displays the video or outputs the sound at the time of reproducing recorded contents. The display device includes a television, a display of a PC, a liquid crystal panel, and etc.

The input device 1303 is a device that inputs control information or data on operations inputted by a user after the user operates the video recorder. The input device 1303 is realized by a remote controller, a keyboard, a mouse, a pointing device such as a pen input device, a liquid crystal touch panel, or the like, for example.

The RAM 1306 is a volatile memory and is a storage that stores temporary data or program processed by the recording and reproduction device 1301.

The tuner 1304 is a part that acquires broadcasting program data tuned by radio waves received from a broadcasting station.

The antenna 1305 is a part that receives broadcasting waves for each digital broadcasting band. For example, an antenna for terrestrial digital broadcasting receives radio waves of a UHF band.

The external storage 1307 is a device that has a large storage capacity and includes an optical disk such as a DVD, etc. or a HDD, for example.

Next, each processing block of the recording and reproduction device 1301 will be described. Each processing block may be processed by software operating in a general-purpose processor such as a CPU, etc. or hardware for exclusive use for each block. Each block may be processed by a device including the software and the hardware.

As shown in FIG. 13, the recording and reproduction device 1301 includes a system control unit 1310, a signal separation unit 1311, a closed caption analyzing unit 1312, a program recording unit 1313, a chapter generation unit 1314, a keyword list accession unit 1315, a position list accession unit 1316, a program reproduction unit 1317, and a video output unit 1318.

The system control unit 1310 controls an operation of each block of the recording and reproduction device 1301 by receiving a user's operation request through the input device 1303. Further, the system control unit 1310 controls the operation of each block of the recording and reproduction device 1301 in recording and reproducing a program.

The signal separation unit 1311 separates received broadcasting data, video data, audio data, a closed caption sentence data, program information data, etc. by each type to other processing blocks. In the case where the signal separation unit 1311 receives a request for data transmission from other processing unit, the signal separation unit 1311 transmits designated data to a request source. Further, the broadcasting program data received from the tuner 1304 or recording program data 1321 stored in the external storage 107 may be inputted into the signal separation unit 1311.

The position list accessing unit 1316 outputs a reproduction position list for the recording program to the video output unit 1318 by the direction of the system control unit 1310.

The program recording unit 1313 acquires the recording program data 1321 stored in the external storage 1307, which is indicated by the user to input the recording program data 1321 into the signal separation unit 1311 by the order of the system control unit 1310. Thereafter, the program recording unit 1313 acquires and decodes a video ES (to be described below) and an audio ES (to be described below) from the signal separation unit 1311 to output the video data and the audio data to the video output unit 1318.

The program recording unit 1313 requests a data stream to the signal separation unit 1311 and stores the recording program data 1321 in the external storage 1307 through the system control unit 1310 in the case of receiving a request for recording the program. The program recording unit 1313 may store all data streams as the recording program data 1321 by user's designation or may store only the video ES or audio ES by selection due to a reduction in a storage area.

The video output unit 1318 configures a screen by receiving outputs of the position list accession unit 1316, or the program reproduction unit 1317 and outputs the video and the audio to the display device 1302.

When the closed caption analyzing unit 1312 receives a request for analyzing a closed caption from the system control unit 1310, the signal separation unit 1311 acquires a closed caption ES (to be described below) and a time stamp. The closed caption analyzing unit 1312 analyzes the closed caption ES and stores closed caption feature data 1320 in the RAM 1306.

The chapter generation unit 1314 outputs chapter data 1323 to the external storage 1307 by using the closed caption feature data 1320 and dictionary data 1322.

The closed caption feature data 1320 is the data that the closed caption analyzing unit 1312 stores in the RAM 1306 after analyzing the closed caption ES. The closed caption feature data 1320 will be described in detail below.

The external storage 1307 stores the recording program data 1321, the dictionary data 1322, and the chapter data 1323.

The dictionary data 1322 is the data in which keywords to be outputted to the caption feature data 1320 are listed. However, in the case where a blank section of the closed caption feature data 1320 is detected, while contents of the closed caption are not analyzed, the dictionary data 1322 may not be provided. The dictionary data 1322 is not in only the external storage 1307, but the dictionary data 1322 may be accessed by Internet, broadcasting waves, a flash memory, etc. A dictionary may be updated from a user's operation history or EPG.

The recording program data 1321 is the program data including information such as the video, the audio, the closed caption, etc.

The chapter data 1323 is the data storing the information on the keywords contained in the closed caption sentence. The chapter data 1323 will be described in detail below.

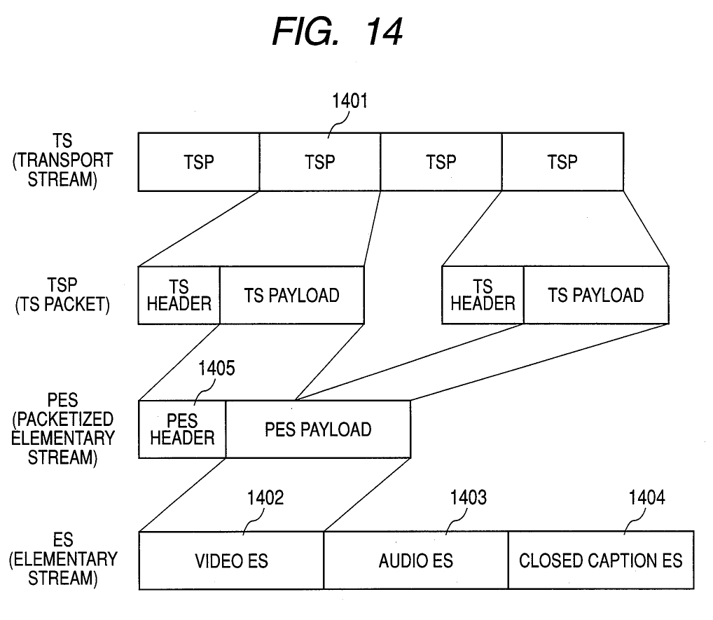

Next, referring to FIGS. 14 to 16, a data structure relating to the video reproduction method according to the embodiment of the present invention will be described.

FIG. 14 is a diagram illustrating a data structure of the data stream in digital broadcasting.

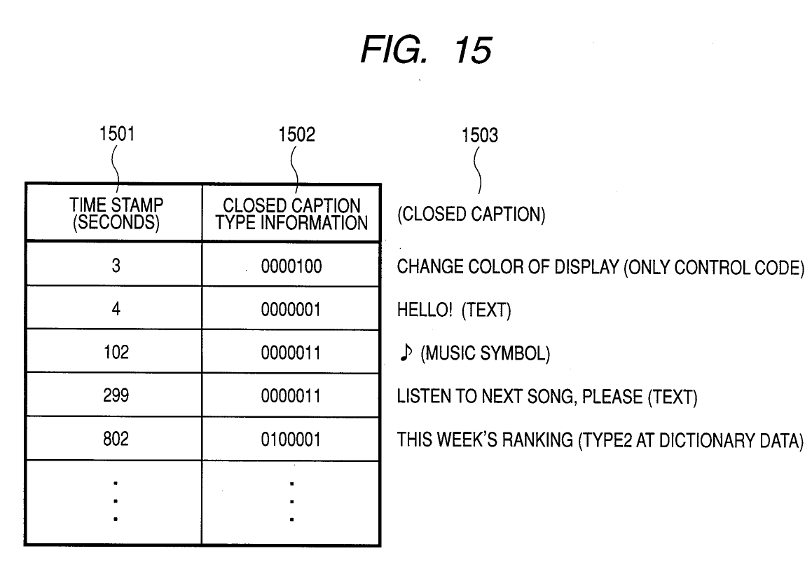

FIG. 15 is a diagram illustrating the form of the closed caption feature data 1320.

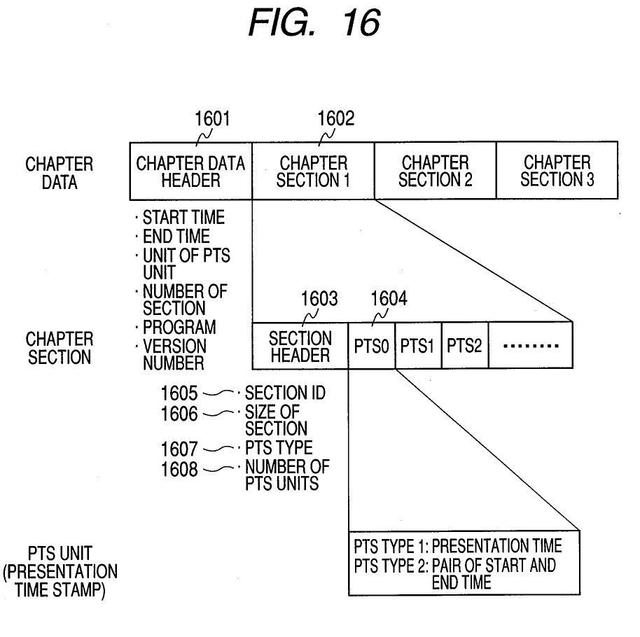

FIG. 16 is a diagram illustrating a data structure of the chapter data 1323.

In the digital broadcasting, an MPEG-2 TS (Transport Stream) is used as a transmission scheme. The video data, the audio data, all the data that are used for data broadcasting are transmitted to a TS packet 1401 shown in FIG. 14.

In particular, the video data, the audio data, and the closed caption sentence data are encoded and compressed in elementary streams to become a video ES 1402, an audio ES 1403, and a closed caption ES 1404.

The ESs are packetized in the form of a PES (Packetized Elementary Stream) to which a PES header 1405 indicating display time information.

The PES header 1405 includes the time stamp. Reproduction synchronization of each packet may be maintained by the time stamp. As known from FIG. 14, one PES packet may be made by the payload of plural TS packets.

The signal separation unit 1311 shown in FIG. 13 analyzes the data streams of FIG. 14 to separate the data stream by each packet type.

Next, referring to FIG. 15, the closed caption feature data 1320 will be described.

As shown in FIG. 15, the closed caption feature data 1320 is stored in a table form of a time stamp 1501 and closed caption type information 1502.

The time stamp 1501 is a closed caption display time included in the PES header 1405 and is displayed as a relative time from a recording start time.

The closed caption type information 1502 stores a result of analyzing the closed caption sentence 1503. A method of analyzing and a method of outputting text information included in the closed caption ES 1404 will be described below.

The closed caption feature data 1320 is accumulated in a predetermined amount depending on the capacity of the RAM 1306. The closed caption analyzing unit 1312 monitors the accumulated data amount of the closed caption feature data 1320. In this case, in the case where the closed caption analyzing unit 1312 determines that the data of a predetermined amount is accumulated in the RAM 1306, the closed caption analyzing unit 1312 notifies a system control unit.

Next, referring to FIG. 16, the chapter data 1323 will be described.

The chapter data 1323 is the data generated for each program. The chapter data 1323 may be used in generating the program using an automatic chapter.

As shown in FIG. 16, the chapter data 1323 has a hierarchical structure. The uppermost layer includes one chapter header 1601 at the header of the layer and plural chapter sections 1602 at the next to the chapter header 1601.

The chapter header 1601 includes data serving as an attribute of the chapter data and only one information piece such as the recording start time or a termination time and the unit of a PTS (Presentation Time Stamp) which is a time indicated by the chapter or the program information. In addition, the chapter header 1601 includes the total number of the chapter sections 1602. The program information is acquired from an EPG. Besides, additional information may be added to the program information in recording such as setting an image quality. Information on the version number of the chapter data or a preparation time may be stored.

The chapter section 1602 is prepared by being separated from other chapter sections by a difference of an attribute of the keyword or a keyword usability determination algorithm. For example, in the case where the chapter sections have different categories of the program, different chapter generation algorithms may be used. Therefore, the chapter sections are prepared in correspondence with the categories of the program. For example, since a category called a sports program and a category called a news program are different in each chapter generation algorithm, an independent chapter section is prepared for each program.

As shown in FIG. 16, each chapter section is partitioned by plural segments having the hierarchical structure. One section header 1603 is configured at the header of the chapter section and plural PTS units 1604 are configured at the next to the section header 1603.

The section header 1603 is the segment representing an attribute of the chapter section. The section header 1603 may include a section ID 1605, a section size 1606, a PTS type 1607, and the number of PTSs 1608, for example.

The section ID 1605 is the ID number representing an attribute of the section aid is unique for each chapter section included in the same chapter data. It is preferable that the program reproduction device treating the chapter data uses the same section ID in the case where chapter data of each of plural programs uses the same chapter generation algorithm in order to determine a using method of the corresponding chapter section by examining the section ID.

The section size 1606 represents an entire size of the corresponding segment. The PTS type 1607 is the code for discriminating an expression method of the PTS included in the PTS unit 1604. An example of the expression method of the PTS will be described below. Further, the PTS number 1608 represents the number of PTS units included in the corresponding segment.

The PTS unit 1604 represents a position of the chapter or a position of a detected scene.

In the PTS unit 1604, methods of storing the position of the chapter and the position of the detected scene are different from each other depending on the PTS type 1607 included in the section header 1603. For example, in the PTS 1607, if Type 1 is indicated, only the position of the chapter is stored, while if Type 2 is indicated, the position of the scene is stored depending on a start time and a termination time of the scene.

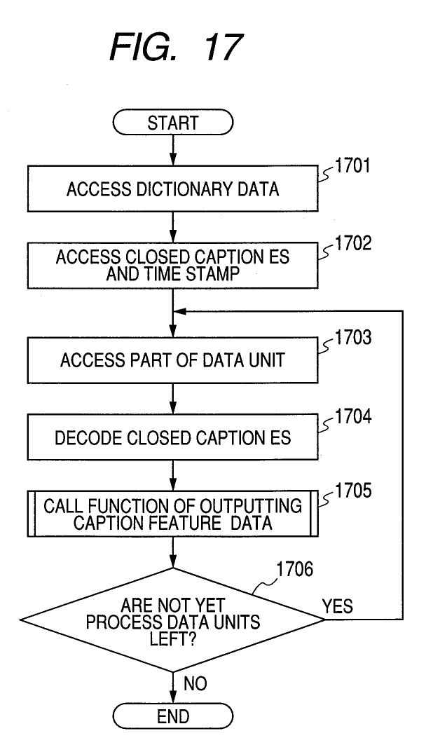

Next, referring to FIGS. 17 to 21, processing each unit of a video reproduction method according to the fourth embodiment of the present invention will be described.

FIG. 17 is a flowchart illustrating a process of generating closed caption feature data in the closed caption analyzing unit 1312.

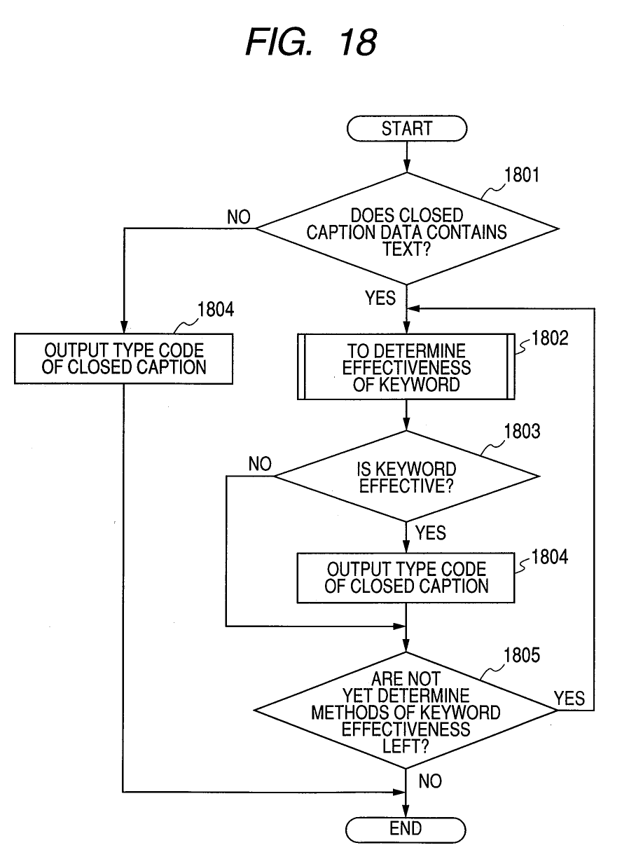

FIG. 18 is a flowchart illustrating an output process of the closed caption feature data in detail.

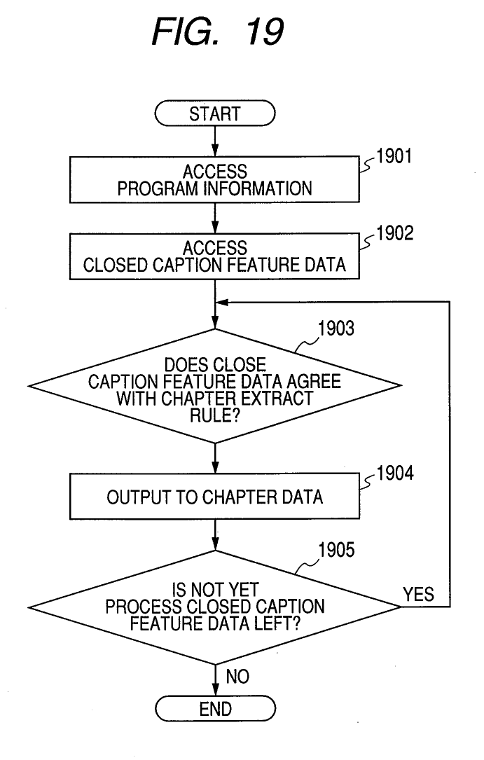

FIG. 19 is a flowchart illustrating a process of generating the chapter data in the chapter generation unit 1314.

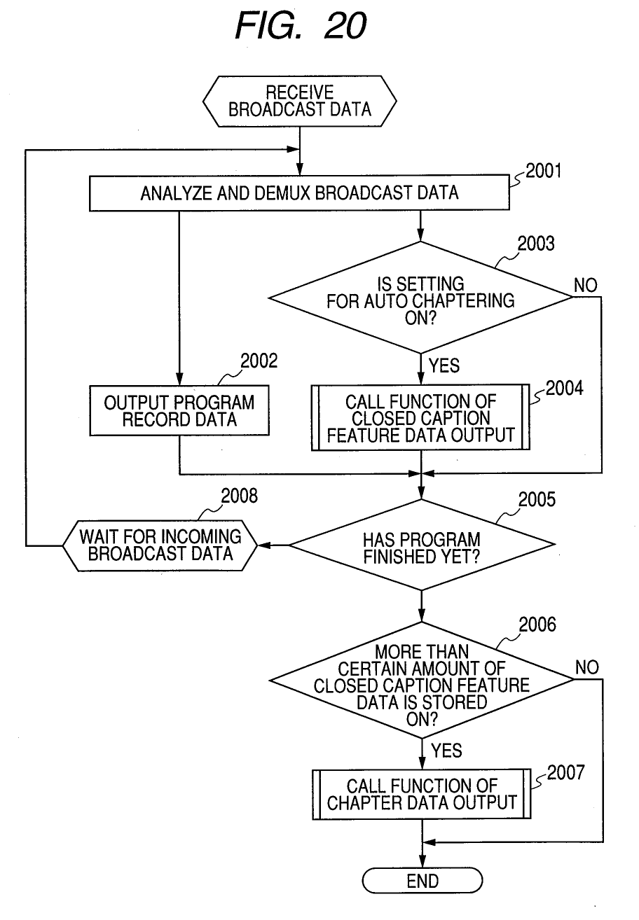

FIG. 20 is a flowchart illustrating a process at the time of recording the program.

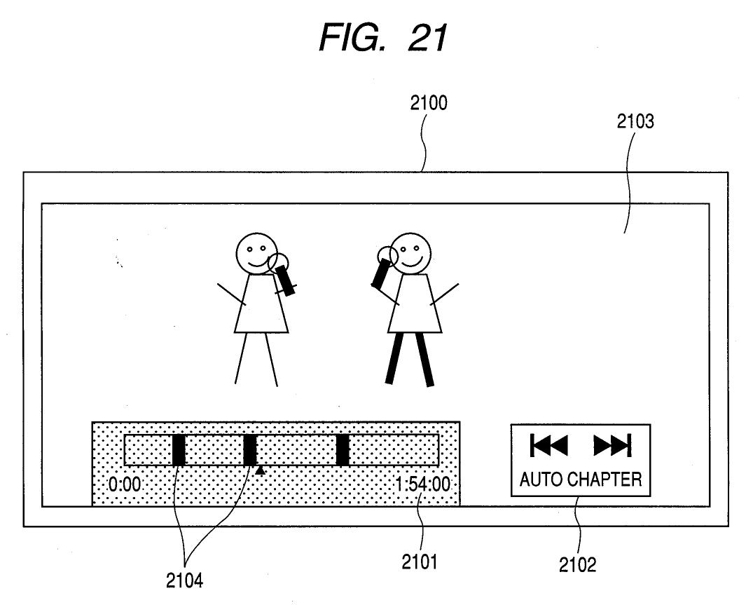

FIG. 21 is a diagram illustrating an example of a user interface of a program reproduction screen that performs automatic chapter reproduction using the closed caption.

First, referring to FIG. 17, the process of generating the closed caption feature data in the closed caption analyzing unit 1312 will be described.

The closed caption analyzing unit 1312 directs a start of the process of generating the closed caption feature data in the system control unit 1310.

The closed caption analyzing unit 1312 firstly acquires the dictionary data 1322 in the external storage 1307 (S1701). However, this step is omitted at the time of generating the closed caption feature data without using the dictionary data 1322.

Next, the closed caption ES and the time stamp are acquired (S1702). The closed caption ES is acquired from the signal separation unit 1311 by analyzing the broadcasting data shown in FIG. 14. Similarly, the time stamp relating to the closed caption ES is also acquired from the PES header 1405.

One data unit is acquired by the closed caption ES (S1703). The data unit is one of components of the closed caption ES described in the ARIB standard. The data unit is divided into groups each having a separate data unit for each language in the case where the closed caption ES includes caption sentence composed of plural languages. A language type can be discriminated by data group IDs included in the data unit.

Next, a decoding process is performed by analyzing the data unit (S1704). The decoding process is performed and then, the closed caption ES shown in FIG. 15 is acquired.

Next, the closed caption feature data is outputted by using the closed caption sentence 1503 acquired in S1704 and the time stamp acquired in S1702 (S1705). The outputting process of the closed caption feature data will be described in detail with reference to FIG. 18.

It is judged whether or not there is an unprocessed data unit in the closed caption ES acquired in S1702. In the case where there is the unprocessed data unit, the process returns to S1703 and processing a subsequent data unit is performed. However, only a data unit including a predetermined language may be processed.

Next, referring to FIG. 18, the outputting process of the closed caption feature data will be described in detail. First, it is judged that the closed caption sentence 1503 acquired in S1703 includes a text (S1801).

As shown in the closed caption sentence 1503 of FIG. 15, a character string “Hello.” is included in the data unit. The font color is changed or a display closed caption sentence is erased at one side. Control data on a method of displaying the closed caption or symbolic data which is drawn as a bitmap is included in the data unit.

In S1801, in the case where it is judged that the text is included in the closed caption sentence 1503 acquired in S1703, a judgment process of a valid keyword is performed (S1802). In the effective keyword judgment process, for example, it is judged that word data included in the dictionary data 1322 or detection phrases included in the system are included.

For example, in case of a music program, the music program is composed of plural program numbers and a chapter is automatically attached to the head of music. In this step, it is judged that phrases “the next song, please.”, etc. assumed as a paragraph of the music or a symbol such as “ [symbol] ” (a note) displayed in the case where a music is played.

In the judgment result in S1802, in the case where it is judged that the effective keyword is included (S1803), the judgment result is outputted to the closed caption type information 1502 (S1804). In S1801, in the case where it is judged that the text is not included in the closed caption sentence 1503 acquired in S1703, the same process is performed.

For example, as shown in FIG. 15, the closed caption type information 1502 expresses various types of content information as a bit flag to store plural types and stores the various types of content information by coding the content information by a decimal number, etc. For example, in case of data including the text, each 1 bit is set to 1. In case of data including only the control code, each 3 bit is set to 1. In case of data including a keyword on the music, each 2 bit is set to 1. In addition, in case of data including other keywords, any bit is set to 1. Similarly concerning a bit map symbol, etc., each 2 bit is set to 1 for the symbol relating to the music and any bit is set to 1 in order to include a bitmap symbol.

In describing by the example of FIG. 15, in the case where the closed caption ES including the control data such as the change of the font color in a time stamp 3 is acquired, each least significant 3 bit is set to 1 as only a code is included in the data. Next, in the case where closed caption sentence data including the text “Hello.” in a time stamp 4 is acquired, each least significant 1 bit is set to 1 as the text is included in the data. Subsequently, in the case where the closed caption sentence data including the text that includes the music symbol such as a note in a time stamp 1302 is acquired, each least significant 1 bit and each least significant 2 bit are set to 1 at once by including the text and the keyword on the music. Each least significant 1 bit and each least significant 2 bit are set to 1 at once by including the text “the next song, please.” and the keyword on the music in a time stamp 299. Subsequently, in a time stamp 802, in the case where the closed caption sentence data including a text “this-week's ranking” is acquired, a keyword called “ranking” is included in the dictionary keyword 122 and, each least significant 1 bit and each least significant 6 bit are set to 1 at once.

As described above, information on whether or not the keyword agrees with the type of the closed caption sentence data or each keyword of the dictionary data 1322 is stored in the closed caption type information 1502. Although the closed caption type information 1502 may be stored in the bit flag as shown in FIG. 15, but for example, in the case where the dictionary data becomes huge, the closed caption type information 1502 is not expressed by a bit and only in the case that it is judged that the closed caption type information 1502 is included, only the dictionary data may be expressed by separate data. As described in the example, it is preferable to consider a process in the subsequent chapter generation unit for the keywords detected in the same category, such as a note or “Next song, please”.

As described above, the outputting process of the closed caption type information of S1804 is performed. Next, it is judged whether or not there is that an unadjusted effective keyword judgment method (S1805). In the case where the keyword is not judged as the effective keyword in S1803, the process proceeds directly to S1805. In the case where it is judged that the effective keyword judgment method remains, the process returns to S1802 and the next keyword judgment method is applied. In the case where plural keyword judgment methods are performed, a result thereof is merged with the previous closed caption type information.

In S1805, in the case where it is judged that all effective keyword judgment methods are performed, the process is terminated. In S1801, in the case where it is judged that the text is not included, the process is terminated after the outputting process to the closed caption type information of S1804 is performed.

Next, referring to FIG. 19, a process of generating the chapter data in the chapter generation unit 1314 will be described.

The chapter generation unit 1314 directs a start of the process of generating the chapter data in the system control unit 1310.

The chapter generation unit 1314 firstly acquires the program information (S1901). The program information includes an electronic program guide (EPG), and the like in the digital broadcasting. The program information is acquired from the signal separation unit 1311 by analyzing the broadcasting data or the program record data 1321 shown in FIG. 14.

In the closed caption feature data shown in FIG. 15, the time stamp 1501 and the closed caption type information 1502 are acquired as one record (S1902).

Next, it is judged whether or not that the taken-out closed caption feature data conforms to a chapter extraction rule (S1903). The chapter extraction rule is a rule which can be used for judging whether or not the inputted closed caption feature data 1320 is a predetermined pattern. The chapter extraction rule evaluates the closed caption type information and a temporal interval thereof for the one record acquired in S1902.

For example, the chapter extraction rule for the music program will be described. A rule for establishing the chapter in the head of the music number is applied to the music program. Therefore, the closed caption feature data including the keyword relating to the music is found by evaluating the closed caption feature data by one record. In the case where the closed caption feature data shown in FIG. 15 is acquired, the time stamp 102 conforms to the condition. Next, a record type and a temporal interval following the conformed closed caption feature data are evaluated. In case of the closed caption feature data shown in FIG. 15, the subsequent record is a character string and the temporal interval 290−102=197. In the case where a closed caption feature interval cannot be acquired at a predetermined interval or more due to appearing of the music, keyword, there is a high possibility that the data will be the scene of the music. Therefore, the data of the time stamp 102 agrees with the chapter extraction rule.

The chapter extraction rule can have plural rules for each category of the program. There is established a rule of establishing the appearing of the dictionary keyword as the chapter by matching with the dictionary keyword provided as the feature data or detecting a predetermined section without the character string or a rule of establishing the chapter at the lead of the subsequent character string in the case where a section without a character string regarded as a CM section is continued for a predetermined section or more. The rules can be applied at once.

In S1903, in the case where it is judged that the closed caption feature data conforms to the chapter extraction rule, the closed caption feature data is outputted to the chapter data (S1904). In FIG. 15, since the data of the time stamp 102 conforms to the chapter extraction rule, the time stamp 102 is outputted to the PTS unit of the music program section for the chapter data of FIG. 16. In the case where the rule having plural category rules are adopted, the category rules are outputted to the PTS units in the category section that conforms to the chapter extraction rule.

A termination point can be stored in the PTS unit of the chapter data of FIG. 16 in addition to a beginning point of the chapter by the expression of the PTS type 1607. A method of storing the PTS is controlled by the chapter extraction rule of each category.

In the case where the chapter data does not conform to the chapter extraction rule in S1903 after the chapter data is outputted in S1904, it is judged whether or not there is a subsequent closed caption feature data record (S1905). In the case where it is judged that there are the rest closed caption feature data, the process returns to S1903 and a subsequent record is evaluated. In S1905, in the case where it is judged that processing all the closed caption feature data is performed, the chapter generation unit 1314 terminates the processing.

Although not shown in FIG. 13, the chapter extraction rule may be stored in the chapter generation unit 1314 as the control data of the chapter generation unit 1314 and may be outputted by being stored in external storage 1307 as necessary.

If the category of the program is a lot and a calculation amount for judging the chapter extraction rule or the chapter data 1323 becomes larger, an output category may be reduced by applying a member for limiting the category. For example, in the program information included in the EPG of the digital broadcasting, plural genre codes may be granted to one program. Accordingly, a separate chapter section 1602 may be outputted for each genre code by judging the effective keyword by an algorithm suitable for the genre which can be acquired by the genre codes.

It is not necessary to establish rules for all categories and the chapter extraction rule for a common rule category may be formed. For example, a chapter extraction rule of establishing the chapter only at the termination point of a part regarded as the CM section is established. For example, a common rule can be applied besides the music program.

Next, referring to FIG. 20, a process of the recording and reproduction device in recording the program will be described.

Even when the user directs recording the program, the process shown in FIG. 20 is followed, the program record data 1321 is outputted, and the closed caption feature data 1320 and the chapter data 1323 are generated.

First of all, the system control unit 1310 directs a change of a program recording state by reservation recording of the program or a user's recording direction. The signal separation unit 1311 separates the broadcasting data having the format shown in FIG. 14 on the basis of a transmission request registered before analysis and recording at the time of receiving the broadcasting data (S2001). Thereafter, the signal separation unit 1311 transmits desired data to the program recording unit 1313 and the closed caption analyzing unit 1314. The program recording unit 1313 records the program record data 1321 in the external storage 1307 (S2002).

Meanwhile, the system control unit 1310 judges whether or not the automatic chapter is performed by setting at the time of user's starting the recording or setting a recording method of the system (S2003). If it is judged that the generation of the automatic chapter is on, the closed caption ES 1404 is inputted into the closed caption analyzing unit 1312 and the closed caption analyzing unit 1312 is outputted to the closed caption feature data 1320 (S2004).

When the automatic chapter is off in S2003 and after S2004 is terminated, it is judged whether or not the program is terminated (S2005). At this time, when the program is terminated, the system control unit 1310 judges whether or not the closed caption feature data of a predetermined amount or more is accumulated (S2006). In the case where the closed caption feature data of the predetermined amount is accumulated, the chapter generation unit 1314 generates the chapter data by using the closed caption feature data 1320 in the RAM 1306 (S2007) and terminates the process. In the case where it is judged that the closed caption feature data 1320 of the predetermined amount or more is not accumulated in the RAM 1306 in S2006, the chapter generation unit 1314 terminates the process without generating the chapter data. In the case where the program is not terminated in S2005, a broadcasting data receiving stand-by state is again maintained thereafter (S2008).

Next, referring to FIG. 21, a user interface at the time of reproducing the automatic chapter using the closed caption will be described.

A program reproduction screen 2100 that is capable of reproducing the chapter according to the embodiment of the present invention includes a progress bar display unit 2101, an automatic chapter reproduction display unit 2102, and a program video display unit 2103.

The program reproduction screen 2100 capable of reproducing the chapter according to the embodiment of the present invention is actuated when the user directs the program reproduction using the closed caption through the input device 1303.

In the progress bar display unit 2101, a progress bar indicating an entire length of the program is displayed and a reproduction position of the chapter in accordance with a content of the chapter data 1323 of the corresponding program is displayed as a chapter position 2104.

When the program reproduction is directed, the category information of the corresponding program is inputted into the position list accession unit 1316. The position list accession unit 1316 selects the chapter section 1602 among the chapter data 1323 of the corresponding program and acquires all PTS units 1604 included in the chapter section. Subsequently, the acquired PTS unit 1604 is transferred to the video output unit 1318. The video output unit 1318 displays a reproduction position of a chapter corresponding to the acquired PTS unit 1604 on the progress bar. Herein, the video output unit 1318 displays only an appearing position other than a standard color of the progress bar in the case where the PTS unit 1604 is the type 1 (appearing time type) shown in FIG. 16. Meanwhile, in the case where the PTS unit 1604 is the type 2 shown in FIG. 18, an interval enclosed by start and termination times is displayed in a color other than the standard color of the progress bar.

The chapter data supports storing of plural sections, thus, there is a possibility that all categories that the system supports will be outputted at the time of generating the chapter data. The position list accession unit 1316 specifies the chapter section 1602 of a genre which can be acquired from the genre code in accordance with the genre code granted to the program information included in the EPG of the digital broadcasting at the time of reproducing the program and acquires the list of the PTS unit in the specific chapter section 1602.

In this case, in the case where the type of the corresponding genre code includes categories such as “music”, “news”, and “sport”, a chapter section 1 is acquired from the chapter section 1602 for “music”, a chapter section 2 is acquired from the chapter section 1602 for “news”, and a chapter section 3 is acquired from the chapter section 1602 for “sport”. That is, different chapter sections may be acquired depending on the genre code. In this case, different chapters can be selected for each type of the program and the program can be reproduced by using the chapter position more suitable for the content of the program.

There is a possibility that plural genres will be included in the genre code granted to the program information included in the EPG of the digital broadcasting. In this case, the position list accession unit 1316 may examine some or all genre codes, and acquires and display the PTS units of all chapter sections that match with the genre codes.

In this case, in the above-described example in which the type of the corresponding genre code includes “music”, “news”, and “sport”, in the case where a genre code of a predetermined program includes both “news” and “sport”, it is preferable to acquire both the chapter section 2 and the chapter section 3 in the chapter section 1602. In this case, if the genre code of the program includes plural codes, all chapters corresponding to the plural codes can be used.

At the time when the category included in the chapter data 1323 is firstly found, searching the chapter section may be terminated.

In this case, in the above-described example in which the type of the corresponding genre code includes “music”, “news”, and “sport”, in the case where both “news” and “sport” are included in the genre code of the predetermined code and “news” is found, first of all, it is preferable to acquire the chapter section 2 in the chapter section 1602. This case becomes more convenient, thus, it is possible to perform the process at high speed.

Only an initial genre code is examined. At this time, when the initial genre code may be matched, the PTS unit of the corresponding section is acquired, while when the initial genre code is not matched, the PTS unit of the chapter section for the common rule may be acquired. Even in this case, it is possible to perform the process more conveniently.

Besides the chapter section for each genre code, the chapter section for the common rule is prepared and if the genre code is not found, the chapter section for the common rule may be acquired.

In generating the chapter by using the chapter generation unit 1314, the category of the program is specified by using the genre code granted to the program information included in the EPG of the digital broadcasting and the chapter may be generated by using the rule of the specific category. That is, the generation rule of the chapter may be modified in accordance with the genre code granted to the program information, which generates the chapter in generating the chapter. In this case, the chapter section is not searched in reproduction and in spite of the reproduction, it is possible to perform reproduction suitable for each category. That is, it is possible to reduce the amount processed in the reproduction while performing the reproduction suitable for each category.

An option screen for selecting the category may be displayed by user's designation. In that case, the PTS unit of the chapter section matched with the corresponding category is acquired.

A position of each chapter acquired by the position list accession unit 1316 is evaluated by considering the state of the system. In the case where previous and next chapters are separated from each other by a predetermined gap or less, the chapters are collected in one chapter. In a method of collecting the chapters, the chapters may be collected in the previous or next chapter in a predetermined direction or the chapters may be collected in different directions for each category. For example, in the music program, in the case where the leading position and the CM position of the music are displayed as the chapter at once, the leading position of the music is detected directly after the CM is terminated, the chapters are collected at the leading position of the music, which is positioned at a posterior side. In the case where the appearing position and the chapter position which are included in the dictionary data 1322 are displayed in other categories, the chapters may be collected in the previous chapter.

The progress bar display unit 2101 can perform the reproduction by jumping to a chapter positioned at the posterior side the closest to a current reproduction position when receiving a user's jump demand to the next chapter position through the input device 1303. Further, similarly, the progress bar display unit 2101 can perform the reproduction by jumping to a chapter positioned at the posterior side the closest to a current reproduction position when receiving a user's jump demand to the previous chapter position. However, the progress bar display unit 2101 jumps to the previous two chapters when receiving a user's jump demand to the previous chapter position at the time of reproducing a reproduction position within a predetermined time.

The automatic chapter reproduction method display unit 2102 allows the user to see a method of using the automatic chapter. For example, it is possible to display the method of using the automatic chapter only at the time of reproducing a program in which the automatic chapter is available. It is possible to interfere with a seeing screen by erasing the method of using the automatic chapter with the progress bar display unit 2101 a predetermined time after the reproduction is started. Only when a special operation such as the jump demand, a scroll-up, or a fast forwarding operation, the method of using the automatic chapter may be displayed.

Therefore, it is possible to reproduce the automatic chapter only when the user selects the program reproduction.

Among the progress bar display unit 2101 and the chapter position 904, the method of using the automatic chapter may be displayed only at the time of reproducing the automatic chapter or the automatic chapter reproduction method display unit 2102 may not display the method of using the automatic chapter in the case of performing time-shift reproduction, that is, concurrently performing a recording operation in the program recording unit and the reproduction operation in the program reproduction unit.

The recording and reproduction device according to the embodiment of the present invention analyzes the closed caption data during the recording, generates the closed caption feature data 122, and the chapter data 1323 just after the recording, but the recording and reproduction device may generate the closed caption feature data 1320 and the chapter data 1323 when the user does not use the recording and reproduction device such as at free times at midnight.

The recording and reproduction device according to the embodiment of the present invention stores the closed caption sentence itself but the closed caption feature data as shown in FIG. 3 in order to save the quantity of the RAM 1306 consumed, but in the case where the large capacity of RAM can be used, all caption sentence data may be stored analyzed in the chapter generation unit 1314. In the case where the capacity of the RAM 1306 is small and the closed caption feature data 1320 cannot be stored in the RAM 1306 during the recording, the closed caption analyzing unit 1312 may limit the output of the closed caption feature data. In this case, the chapter generation unit 1314 generates a chapter of the amount on the way to the recording program.

The recording and reproduction device according to the embodiment of the present invention generates the chapter data 1323 as the closed caption data of the digital broadcasting, but may reflect a scene detection result besides the closed caption to the chapter data 1323 by analyzing the video or the sound. For example, a separate chapter section may be outputted by using a telop recognition result or a CM detection result in the video.

In the program recording and reproduction device according to the embodiment of the present invention, in the case where the program record data 1323 is copied or transferred to a separate recording medium from the external storage 1307, the program record data 1321 may be transferred with the chapter data 1323. For example, even in a reproduction-only player, the automatic chapter reproduction using the closed caption can be performed by installing the position list accession unit 1316.

According to the present invention, in the case of recording and reproducing the digital broadcasting program, it is possible to perform both the reproduction by the optimal index using the closed caption and the reproduction by the keyword voluntarily inputted by the user.

According to the present invention, it is possible to provide the user interface that displays the scene including the keyword in the closed caption so as to allow the user to easily know the scene.

According to the present invention, it is possible to search the keyword with respect to the keyword voluntarily inputted by the user at high speed.

Further, according to the embodiment of the present invention, it is possible to reproduce the program data having the closed caption data more suitably.

What is claimed is:

1. A video recorder, comprising:
a signal separation unit that receives digital broadcasting and separates the digital broadcasting in accordance with a broadcasting data type;
a closed caption analyzing unit that analyzes a closed caption ES (Elementary Stream) inputted by the signal separation unit, and generates closed caption sentence data including a closed caption sentence, a control code, and a display time;
a program recording unit that records the broadcasting data inputted by the signal separation unit in a storage as recording data;
a video indexing unit that analyzes the closed caption sentence data, generates index data for reproducing a program by an index designated by a user, and outputs the index data to the storage;
a keyword list accession unit that acquires a keyword list serving as a candidate of an index from the index data;
a position list accession unit that acquires a reproduction position list by searching for the index data with respect to a reproduction position of a keyword selected from the keyword list,
wherein in reproducing a record program a part where a position corresponding to the keyword of the index designated by the user agrees with the program is displayed and recording data at the position corresponding to the keyword of the index designated by the user is reproduced.

2. The video recorder according to claim 1, further comprising:
a member through which the user inputs the keyword,
wherein the position list accession unit acquires the reproduction position list by searching for the index data by using the inputted keyword, and
in reproducing the record program, the part where the position corresponding to the inputted keyword matches with the program is displayed and the record data at the position corresponding to the inputted keyword is reproduced.

3. The video recorder according to claim 1, further comprising:
a member through which the user selects a category of the program,
wherein in reproducing the record program, the index data has an area for storing a separate keyword for each category of the program, and the part where a position corresponding to the keyword of the category selected by the user matches with the program is displayed and the record data at the position corresponding to the keyword of the category selected by the user is reproduced.

4. The video recorder according to claim 2,
wherein the closed caption analyzing unit extracts an address of a TS (Transport Stream) packet including the closed caption ES inputted by the signal separation unit, and generates and outputs closed caption address data including the address of the TS packet including the closed caption ES to the storage, and
wherein the position list accession unit acquires the reproduction position list by searching the closed caption address data by using the inputted keyword.

5. The video recorder according to claim 2,
wherein the closed caption analyzing unit generates and outputs closed caption PES (Packetized Elementary Stream) data including the closed caption ES inputted by the signal separation unit to the storage, and
wherein the position list accession unit acquires the reproduction position list corresponding to the inputted keyword by searching the closed caption PES data.

6. A video reproduction method, comprising the steps of:
allowing a signal separation unit to receive digital broadcasting and separate the digital broadcasting in accordance with broadcasting data type;
allowing a closed caption analyzing unit to analyze a closed caption ES (Elementary Stream) inputted by the signal separation unit, and generate closed caption sentence data that includes a closed caption sentence, a control code, and a display time;
allowing a program recording unit to record the broadcasting data inputted by the signal separation unit in a storage as record data;
allowing a video indexing unit to analyze the closed caption sentence data and generate index data for reproducing a program by an index designated by a user;
allowing a keyword list accession unit to acquire a keyword list serving as a candidate of an index from the index data;
allowing a position list accession unit to acquire a reproduction position list corresponding to a reproduction position of a keyword selected from the keyword list by searching for the index data;
inputting the keyword of the index designated by the user on a program reproduction screen;
displaying a part where a position corresponding to the keyword of the index designated by the user matches with the program; and
reproducing record data at the position corresponding to the keyword of the index designated by the user.

7. The video reproduction method according to claim 6, further comprising the steps of:
allowing the user to input the keyword;
allowing the position accession unit to acquire the reproduction position list by searching the index data by using the inputted keyword;
displaying a part where a position corresponding to the inputted keyword matches with the program in reproducing the record program; and
reproducing the record data at the position corresponding to the inputted keyword.

8. The video reproduction method according to claim 6, further comprising the steps of:
allowing the user to select a category of the program;
displaying a part where a position corresponding to a keyword of a category selected by the user matches with the program in reproducing the record program; and
reproducing the record data at the position corresponding to the keyword of the category selected by the user.

9. The video reproduction method according to claim 7, further comprising the steps of:
allowing the closed caption analyzing unit to extract an address of a TS (Transport Stream) packet including a closed caption ES inputted by the signal separation unit and generate closed caption address data from the address of the TS packet including the closed caption ES; and
allowing the position list accession unit to search the inputted keyword from the index and acquire the reproduction position list by searching the closed caption address data when the inputted keyword is not found.

10. The video reproduction method according to claim 7, further comprising the steps of:
allowing the closed caption analyzing unit to generate and output closed caption PES (Packetized Elementary Stream) data including the closed caption ES inputted by the signal separation unit to the storage; and
allowing the position list accession unit to search the inputted keyword from the index and acquire the reproduction position list by searching the closed caption PES data when the inputted keyword is not found.

11. A recording and reproduction device, comprising:
a signal separation unit that receives digital broadcasting and separates the digital broadcasting in accordance with broadcasting data type;
a closed caption analyzing unit that analyzes a closed caption ES (Elementary Stream) inputted by the signal separation unit and generates closed caption feature data including close caption type information including a type of a closed caption sentence and a display time;
a program recording unit that records the broadcasting data inputted by the signal separation unit in a storage as record data;
a chapter generation unit that analyzes the closed caption feature data, generates chapter data for reproducing a program by a chapter designated by a user, and outputs the chapter data to the storage;
a position list accession unit that acquires a reproduction position list by searching a chapter position in accordance with a category of the program from the chapter data; and
a program reproduction unit that reproduces the record data recorded in the storage and performs reproduction for changing a reproduction position at the reproduction position included in the reproduction position list acquired by the position list accession unit.

12. The recording and reproduction device according to claim 11,
wherein the chapter reproduction unit generates the chapter data in which the head of the chapter is the head of music when the category of the program is positioned at a music program.

13. The recording and reproduction device according to claim 12,
wherein the chapter generation unit judges the position of the head of the music in the program in accordance with the presence of a musical note mark included in a closed caption or not.

14. The recording and reproduction device according to claim 11,
wherein the position list accession unit acquires reproduction position lists corresponding to genre codes granted to the program included in the digital broadcasting.

15. The recording and reproduction device according to claim 11,
wherein the program generation unit changes a reproduction position of the record data on the basis of the reproduction position list corresponding to the genre codes granted to the program included in the digital broadcasting.

16. The recording and reproduction device according to claim 11,
wherein the position list accession unit concurrently acquires a plurality of reproduction position lists corresponding to a plurality of genre codes in the case where the genre code granted to the program included in the digital broadcasting is in a plurality of types.

17. The recording and reproduction device according to claim 11,
wherein the program reproduction unit changes the reproduction position of the record data on the basis of the reproduction position lists corresponding to the plurality of genre codes in the case where the genre code granted to the program included in the digital broadcasting is in a plurality of types.

18. The recording and reproduction device according to claim 11, further comprising:
a system control unit that controls the closed caption analyzing unit,
wherein the system control unit judges whether or not an automatic chapter is performed by a recording method set of a system,
the closed caption analyzing unit outputs the closed caption feature data to the chapter generation unit when the system control unit judges that generation of the automatic chapter is set to ‘ON’, and
the closed caption analyzing unit does not output the closed caption feature data to the chapter generation unit when the system control unit judges that the generation of the automatic chapter is ‘OFF’.

19. The recording and reproduction device according to claim 11, further comprising:
the system control unit that controls the closed caption analyzing unit,
wherein the system control unit judges whether or not an automatic chapter is performed by a recording method set of a system,
the chapter generation unit generates the chapter data when the system control unit judges that generation of the automatic chapter is set to ‘ON’, and
the chapter generation unit does not generate the chapter data when the system control unit judges that the generation of the automatic chapter is ‘OFF’.

20. The recording and reproduction device according to claim 11, further comprising:
a display unit that displays the record data generated by the program generation unit,
wherein the display unit performs a displaying operation for displaying a method of using the automatic chapter at the time of reproducing a program in which the automatic chapter is available.

21. The recording and reproduction device according to claim 11,
wherein the chapter generation unit changes a generation rule of the chapter in accordance with genre code granted to the program included in the digital broadcasting.
